(19) United States
(12) Patent Application Publication
(10) Pub. No.: US 2013/0086056 A1
(43) Pub. Date: Apr. 4, 2013

(54) GESTURE BASED CONTEXT MENUS

(71) Applicants: Matthew G. Dyor, Bellevue, WA (US); Royce A. Levien, Lexington, MA (US); Richard T. Lord, Tacoma, WA (US); Robert W. Lord, Seattle, WA (US); Mark A. Malamud, Seattle, WA (US); Xuedong Huang, Bellevue, WA (US); Marc E. Davis, San Francisco, CA (US)

(72) Inventors: Matthew G. Dyor, Bellevue, WA (US); Royce A. Levien, Lexington, MA (US); Richard T. Lord, Tacoma, WA (US); Robert W. Lord, Seattle, WA (US); Mark A. Malamud, Seattle, WA (US); Xuedong Huang, Bellevue, WA (US); Marc E. Davis, San Francisco, CA (US)

(21) Appl. No.: 13/278,680

(22) Filed: Oct. 21, 2011

Related U.S. Application Data
(63) Continuation-in-part of application No. 13/251,046, filed on Sep. 30, 2011.
Application No. 13/251,046 is a continuation-in-part of application No. 13/269,466, filed on Oct. 7, 2011.

(51) Int. Cl. G06F 3/048; G06F 3/16; G06F 17/30

(52) U.S. Cl. 707/730; 715/808; 715/781; 715/728; 707/E17.014

(57) ABSTRACT

Methods, systems, and techniques for providing context menus based upon gestured input are provided. Example embodiments provide a Gesture Based Context Menu System, which enables a gesture-based user interface to invoke a context menu to present one or more choices of next actions and/or entities based upon the context indicated by the gestured input and a set of criteria. In overview, the GBCMS allows an area of electronically presented content to be dynamically indicated by a gesture and then examines the indicated area in conjunction with a set of criteria to determine and present a context menu of further choices available to the user. The choices may be presented in the form of, for example, a pop-up menu, a pull-down menu, an interest wheel, or a rectangular or non-rectangular menu. In some embodiments the menus dynamically change as the gesture is modified.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)). All subject matter of the Related Applications and of any and all parent, grandparent, great-grandparent, etc. applications of the Related Applications is incorporated herein by reference to the extent such subject matter is not inconsistent herewith.

### RELATED APPLICATIONS

For purposes of the USPTO extra-statutory requirements, the present application constitutes a continuation-in-part of U.S. patent application Ser. No. 13/251,046, entitled GESTURELET BASED NAVIGATION TO AUXILIARY CONTENT, naming Matthew Dyor, Royce Levien, Richard T. Lord, Robert W. Lord, Mark Malamud as inventors, filed 30 Sep. 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/269,466, entitled PERSISTENT GESTURELETS, naming Matthew Dyor, Royce Levien, Richard T. Lord, Robert W. Lord, Mark Malamud as inventors, filed 7 Oct. 2011, which is currently co-pending, or is an application of which a currently co-pending application is entitled to the benefit of the filing date.

### TECHNICAL FIELD

The present disclosure relates to methods, techniques, and systems for providing a gesture-based user interface to users and, in particular, to methods, techniques, and systems for providing context menus based upon gestured input.

### BACKGROUND

As massive amounts of information continue to become progressively more available to users connected via a network, such as the Internet, a company intranet, or a proprietary network, it is becoming increasingly more difficult for a user to find particular information that is relevant, such as for a task, information discovery, or for some other purpose. Typically, a user invokes one or more search engines and provides them with keywords that are meant to cause the search engine to return results that are relevant because they contain the same or similar keywords to the ones submitted by the user. Often, the user iterates using this process until he or she believes that the results returned are sufficiently close to what is desired. The better the user understands or knows what he or she is looking for, often the more relevant the results. Thus, such tools can often be frustrating when employed for information discovery where the user may or may not know much about the topic at hand.

Different search engines and search technology have been developed to increase the precision and correctness of search results returned, including arming such tools with the ability to add useful additional search terms (e.g., synonyms), rephrase queries, and take into account document related information such as whether a user-specified keyword appears in a particular position in a document. In addition, search engines that utilize natural language processing capabilities have been developed.

In addition, it has becoming increasingly more difficult for a user to navigate the information and remember what information was visited, even if the user knows what he or she is looking for. Although bookmarks available in some client applications (such as a web browser) provide an easy way for a user to return to a known location (e.g., web page), they do not provide a dynamic memory that assists a user from going from one display or document to another, and then to another. Some applications provide “hyperlinks,” which are cross-references to other information, typically a document or a portion of a document. These hyperlink cross-references are typically selectable, and when selected by a user (such as by using an input device such as a mouse, pointer, pen device, etc.), result in the other information being displayed to the user. For example, a user running a web browser that communicates via the World Wide Web network may select a hyperlink displayed on a web page to navigate to another page encoded by the hyperlink. Hyperlinks are typically placed into a document by the document author or creator, and, in any case, are embedded into the electronic representation of the document. When the location of the other information changes, the hyperlink is “broken” until it is updated and/or replaced. In some systems, users can also create such links in a document, which are then stored as part of the document representation.

Even with advancements, searching and navigating the morass of information is oft times still a frustrating user experience.

### BRIEF DESCRIPTION OF THE DRAWINGS

FIG. 1A is a block diagram of example gesture based context menu produced by an example Gesture Based Context Menu System (GBCMS) or process.

FIG. 1B is a block diagram of an example gesture based context menu produced by an example Gesture Based Context Menu System or process in response to selection of an element from a first context menu.

FIG. 1C is a block diagram of example auxiliary content presented based upon selection of an element from a context menu produced by an example Gesture Based Context Menu System or process.

FIG. 1D is a block diagram of some example types of gesture based context menu views produced by an example Gesture Based Context Menu System or process.

FIG. 1E is a block diagram of an example environment for using gesturelets produced by an example Gesture Based Context Menu System (GBCMS) or process.

FIG. 2A is an example block diagram of components of an example Gesture Based Context Menu System.

FIG. 2B is an example block diagram of further components of the Input Module of an example Gesture Based Context Menu System.

FIG. 2C is an example block diagram of further components of the Context Menu Handling Module of an example Gesture Based Context Menu System.

FIG. 2D is an example block diagram of further components of the Context Menu View Module of an example Gesture Based Context Menu System.

FIG. 2E is an example block diagram of further components of the Action and/or Entity Determination Module of an example Gesture Based Context Menu System.

FIG. 2F is an example block diagram of further components of the Rules for Deriving Actions and/or Entities of an example Gesture Based Context Menu System.

FIG. 2G is an example block diagram of further components of the Auxiliary Content Determination Module of an example Gesture Based Context Menu System.

FIG. 2H is an example block diagram of further components of the Presentation Module of an example Gesture Based Context Menu System.

FIG. 3 is an example flow diagram of example logic for providing a gesture based context menu for providing auxiliary content.

FIG. 4A is an example flow diagram of example logic illustrating various example embodiments of block 304 of FIG. 3.

FIG. 4B is an example flow diagram of example logic illustrating various example embodiments of block 304 of FIG. 3.

FIG. 4C is an example flow diagram of example logic illustrating various example embodiments of block 304 of FIG. 3.

FIG. 4D is an example flow diagram of example logic illustrating various example embodiments of block 304 of FIG. 3.

FIG. 5 is an example flow diagram of example logic illustrating various example embodiments of block 304 of FIG. 3.

FIG. 6 is an example flow diagram of example logic illustrating various example embodiments of block 304 of FIG. 3.

FIG. 7 is an example flow diagram of example logic illustrating various example embodiments of block 304 of FIG. 3.

FIG. 8 is an example flow diagram of example logic illustrating various example embodiments of block 304 of FIG. 3.

FIG. 9 is an example flow diagram of example logic illustrating an alternative embodiment for providing a gesture based context menu for providing auxiliary content.

FIG. 10 is an example flow diagram flow diagram of example logic illustrating an alternative embodiment for providing a gesture based context menu for providing auxiliary content.

FIG. 11 is an example flow diagram of example logic illustrating an example embodiment of block 910 and 912 of FIG. 9.

FIG. 12 is an example flow diagram of example logic illustrating an example embodiment of block 912 of FIG. 9.

FIG. 13 is an example flow diagram of example logic illustrating various example embodiments of block 306 of FIG. 3.

FIG. 14 is an example flow diagram of example logic illustrating various example embodiments of block 308 of FIG. 3.

FIG. 15 is an example flow diagram of example logic illustrating an alternative embodiment for providing a gesture based context menu for providing auxiliary content.

FIG. 16 is an example flow diagram of example logic illustrating an example embodiment of block 1510 of FIG. 15.

FIG. 17 is an example flow diagram of example logic illustrating an alternative embodiment for providing a gesture based context menu for providing auxiliary content.

FIG. 18 is an example flow diagram of example logic illustrating an example embodiment of block 1710 of FIG. 17.

FIG. 19 is an example flow diagram of example logic illustrating various example embodiments of block 302 of FIG. 3.

FIG. 20 is an example flow diagram of example logic illustrating various example embodiments of block 302 of FIG. 3.

FIG. 21 is an example flow diagram of example logic illustrating an example embodiment of block 302 of FIG. 3.

FIG. 22 is an example flow diagram of example logic illustrating various example embodiments of block 302 of FIG. 3.

FIG. 23 is an example flow diagram of example logic illustrating an example embodiment of block 302 of FIG. 3.

FIG. 24 is an example flow diagram of example logic illustrating various example embodiments of blocks 302 to 310 of FIG. 3.

FIG. 25 is an example block diagram of a computing system for practicing embodiments of a Gesture Based Context Menu System.

### DETAILED DESCRIPTION

Embodiments described herein provide enhanced computer- and network-based methods, techniques, and systems for providing context menus for navigating to auxiliary content in a gesture based input system. Example embodiments provide a Gesture Based Context Menu System (GBCMS), which enables a gesture-based user interface to invoke (e.g., cause to be executed or generated, use, bring up, cause to be presented, and the like) a context menu to present one or more choices of next actions and/or entities that can be viewed and/or taken. The one or more choices are based upon the context indicated by the gestured input and a set of criteria and ultimately result in the presentation of other (e.g., additional, supplemental, auxiliary, etc.) content. For the purposes of this description, an “entity” is any person, place, or thing, or a representative of the same, such as by an icon, image, video, utterance, etc. An “action” is something that can be performed, for example, as represented by a verb, an icon, an utterance, or the like.

In overview, the GBCMS allows an area of electronically presented content to be dynamically indicated by a gesture. The indicated area may be, for example, a character, word, phrase, icon, image, utterance, command, or the like, and need not be contiguous (e.g., may be formed of non-contiguous portions of the electronically presented content). The gesture may be provided in the form of some type of pointer, for example, a mouse, a touch sensitive display, a wireless device, a human body part, a microphone, a stylus, and/or a pointer that indicates a word, phrase, icon, image, or video, or may be provided in audio form. The GBCMS then examines the indicated area in conjunction with a set of (e.g., one or more) criteria to determine and present a context menu of further choices (e.g., additional actions that can be taken or entities of relevance) available to the user. The one or more choices may be presented in the form of one or more menu items that are selectable by the user.

The GBCMS may determine what actions and/or entities are available and/or relevant based upon context, for example, what the user is doing, what content is being presented, what is important to the user, devices available, what the user's social network is doing, and the like. In addition, the GBCMS may determine what actions and/or entities are available and/or relevant based upon prior history or context, such as prior history associated with the user, attributes of the gesture, the system, or the hardware or software available, or the like. In some examples, the GBCMS takes into account prior history associated with the user including prior search history, prior navigation history, prior purchase or offer history, demographic information (such as age, gender, location, and the like), and the like. Other examples take into account other contextual information. The GBCMS can incorporate any kind of historical or contextual information as long as it is programmed into the system.

Once the GBCMS has presented the context menu, then, upon receiving an indication that one of the menu items has been selected, determines a corresponding next content and presents it to the user. In some cases, the next content is another menu and thus another context menu is presented. In other cases, particular auxiliary content is determined and subsequently displayed to the user. Auxiliary content may be of any form, including, for example, documents, web pages, images, videos, audio, or the like, and may be presented a variety of manners, including visual display, audio display, via a Braille printer, etc., and using different techniques, for example, overlays, animation, etc.

In some embodiments, the gesture based context menu changes based upon certain behaviors demonstrated by the user. For example, if the user modifies the gesture, for example, emphasizing certain parts (making the gesture more bold, harder, louder, etc.), changing the indicated area, changing the shape and/or direction of the gesture, etc., the context menu may in turn be modified and the menu items updated and/or changed. In addition, movement of the gesture may be used to select a menu item, thereby increasing the modes in which menu items are selected from the context menu.

In this manner, a gesture based context menu of the Gesture Based Context Menu System may be used to navigate to further content that is tailored to the context presented to the user and may be dynamically sensitive and adapt to user needs and/or contextual changes.

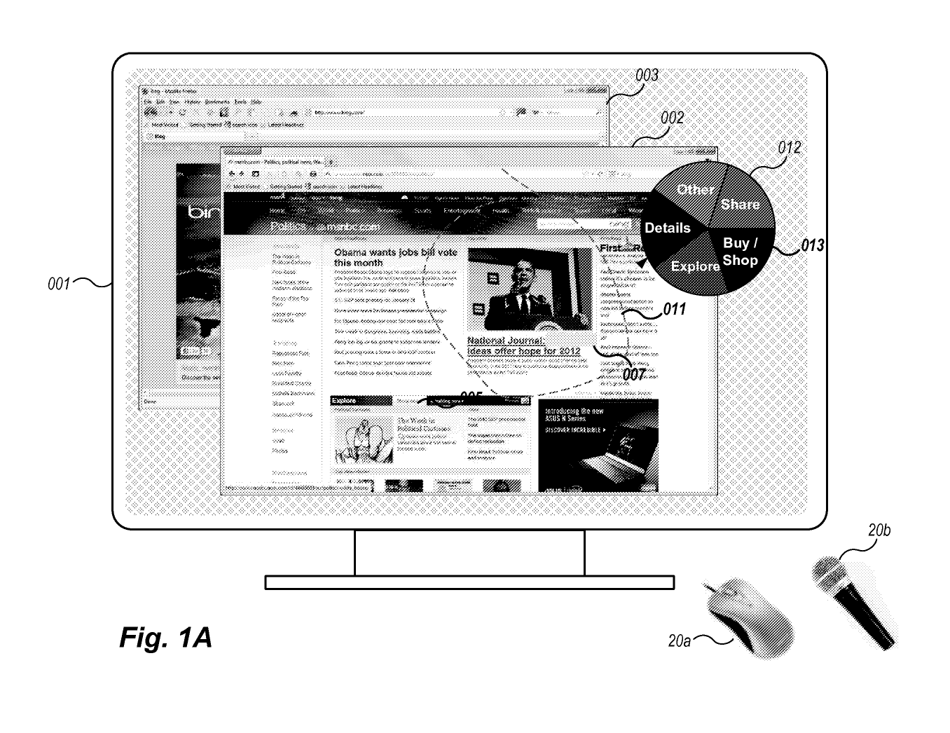

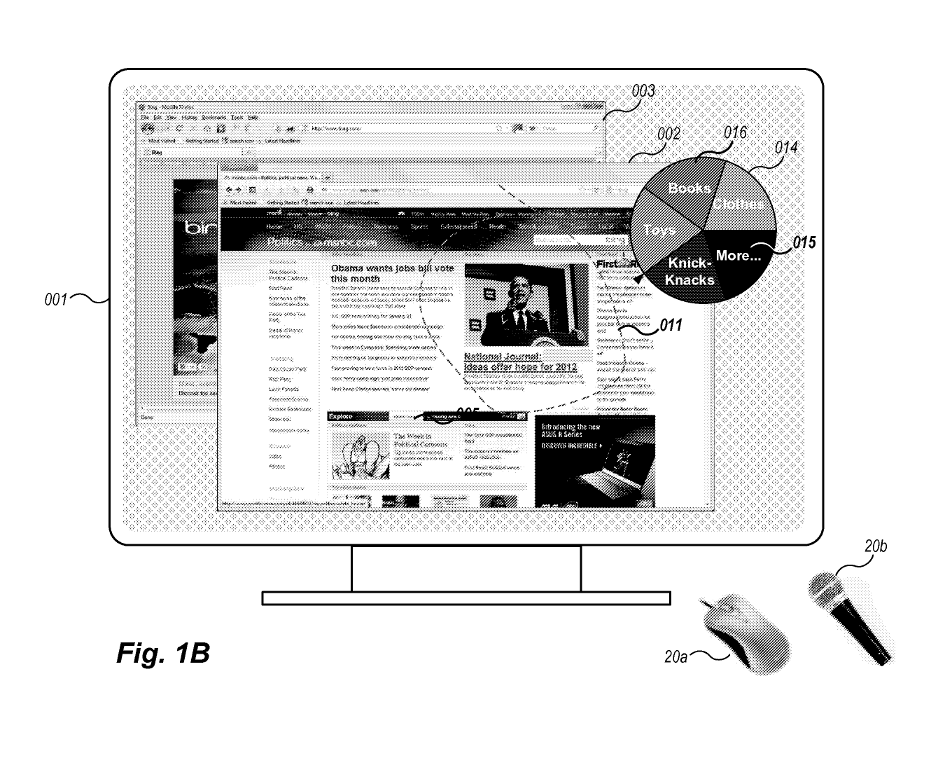

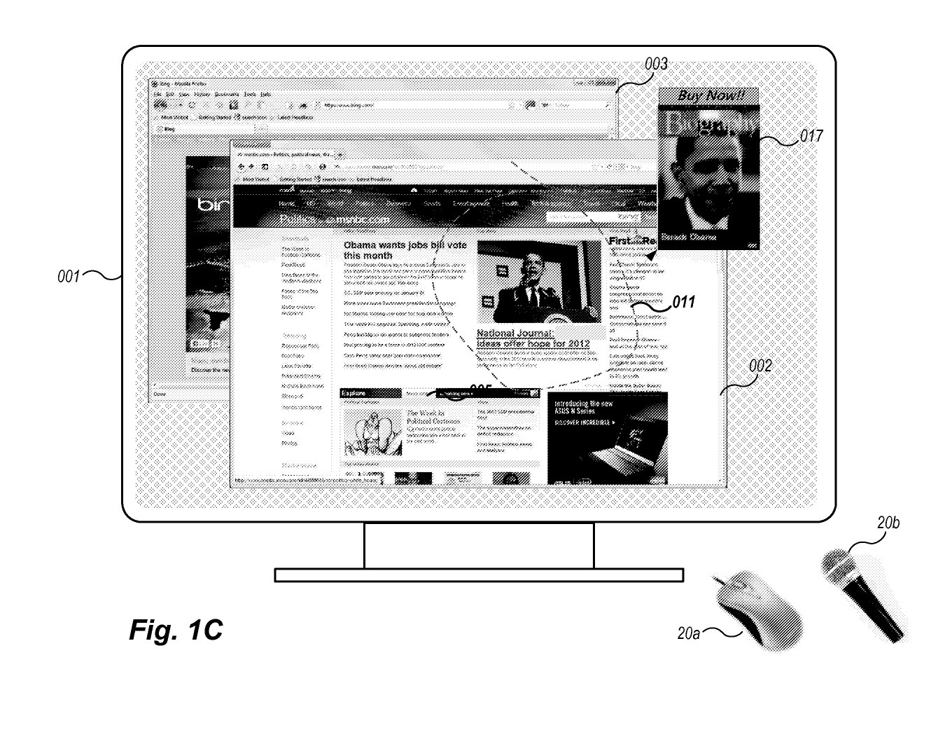

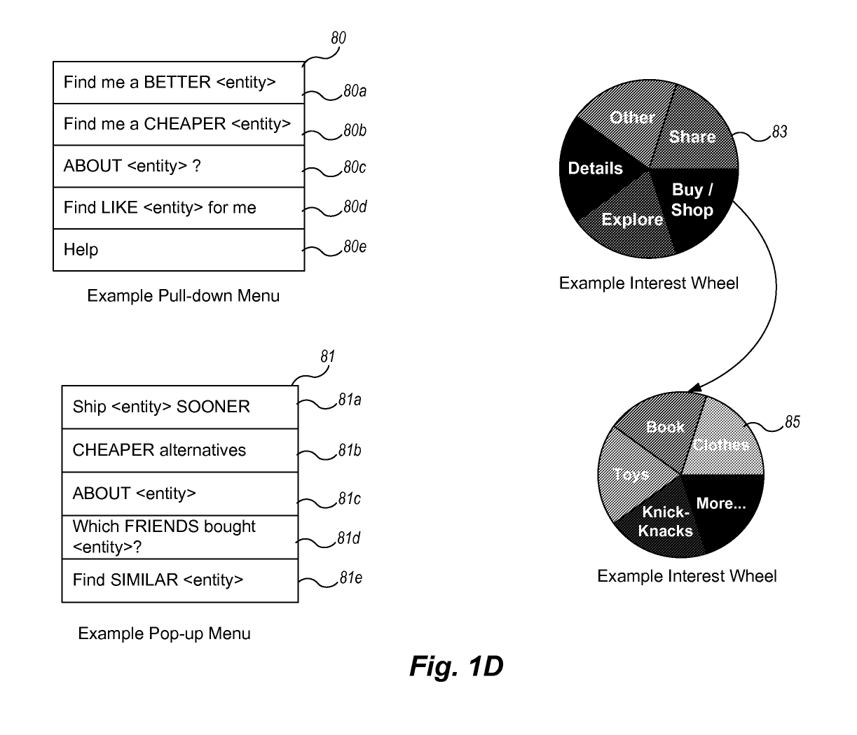

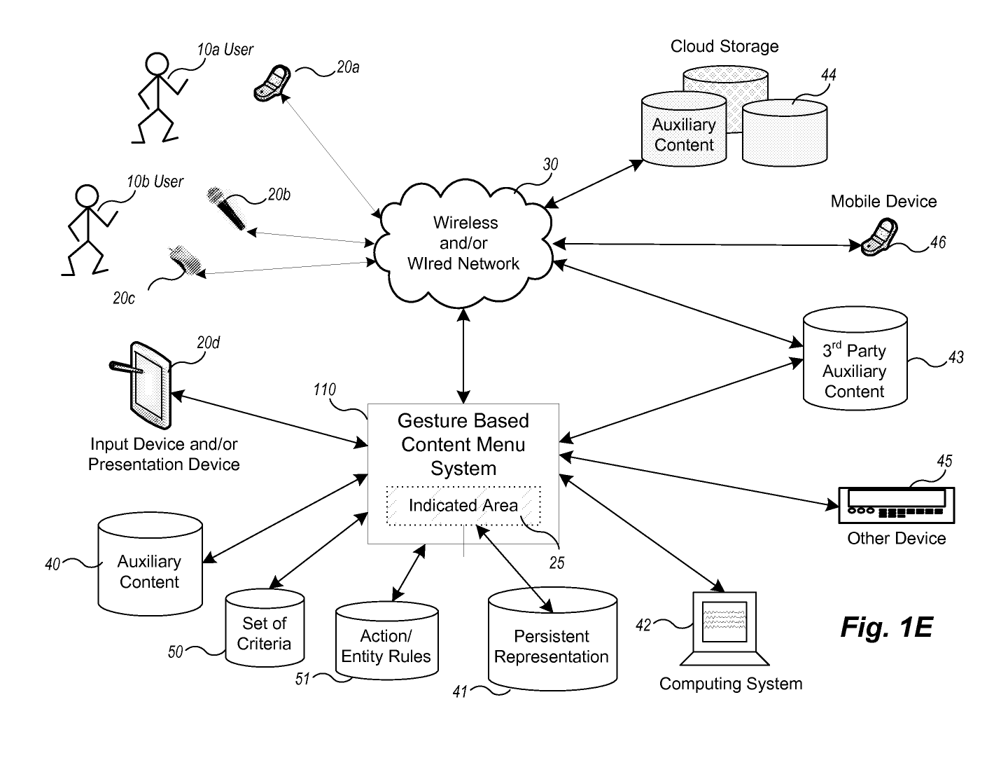

FIG. 1A is a block diagram of example gesture based context menu produced by an example Gesture Based Context Menu System (GBCMS) or process. In FIG. 1A, a presentation device, such as computer display screen 001, is shown presenting two windows with electronic content, window 002 and window 003. The user (not shown) utilizes an input device, such as mouse 20a and/or a microphone 20b, to indicate a gesture (e.g., gesture 011) to the GBCMS. The GBCMS, as will be described in detail elsewhere herein, determines to which portion of the electronic content displayed in window 002 the gesture 011 corresponds, potentially including what type of gesture. In the example illustrated, gesture 011 was created using the mouse device 20a and represents a closed path (shown in red) that is not quite a circle or oval that indicates that the user is interested in the entity “Obama.” The gesture may be a circle, oval, closed path, polygon, or essentially any other shape recognizable by the GBCMS. The gesture may indicate content that is contiguous or non-contiguous. Audio may also be used to indicate some area of the presented content, such as by using a spoken word, phrase, and/or direction. Other embodiments provide additional ways to indicate input by means of a gesture. The GBCMS can be fitted to incorporate any technique for providing a gesture that indicates some area or portion (including any or all) of presented content. The GBCMS has highlighted the text 007 to which gesture 011 is determined to correspond.

In the example illustrated, the GBCMS generates and presents a context menu 012 (which may be implemented, for example, using the user interface controls described elsewhere), which is presented in the form of an “interest wheel” that includes one or more activities that may be of interest given that the user has indicated that the entity “Obama” is of interest. The interest wheel 012 comprises five menu items, including items labeled “buy/shop,” “explore,” “share,” “details,” and “other.” These five are examples of menu items that are relevant and available to the context surrounding the selection of the word representing the entity “Obama.” Other and/or different menu items may be presented for the same entity or for different entities. In some embodiments, the actions “buy,” “share,” and/or “explore” (or their equivalents) provide a set of default actions that are relevant for many entities in many contexts.

When the user selects the menu item “buy/shop” 013 from the context menu 012, the GBCMS presents another context menu to determine what the user would like to buy or look to purchase. FIG. 1B is a block diagram of an example gesture based context menu produced by an example Gesture Based Context Menu System or process in response to selection of an element from a first context menu. In this case, the interest wheel 14 for further buy and/or shop selections is presented to help the user determine what type of service or product related to the entity (here “Obama”) the user would like to purchase. In the example interest wheel 015 shown, four different types of categories are presented as separate menu items: books, clothes, toys, knick-knacks. In addition, a more menu item 015 is available to enable the user to bring up additional choices. Again, this is an example. Other forms of context menus, and other choices may be similarly incorporated. In addition, in this example, the GBCMS has presented the context menus to the “side” of the gestured input, which is marked, here as a red dotted line with the relevant indicated area highlighted as entity 007. In other examples, the gestured indicated area may not be so marked and/or may be marked differently. Also, the context menu may be displayed to overlay the gesture or even in a different area altogether (or, for example, using a different presentation device).

Once the user has selected a choice—a menu item—from the context menu 015, the GBCMS determines and presents content associated with that selection. FIG. 1C is a block diagram of example auxiliary content presented based upon selection of an element from a context menu produced by an example Gesture Based Context Menu System or process. In this case, the user has selected the books menu item (item 016). The GBCMS responds by presenting a selection of a book the user may be interested in purchasing as auxiliary content. Here, an advertisement for a book on the entity “Obama” (the gestured indicated area) represented by image 017 is presented to the user for possible purchase. In this example, the GBCMS presents the auxiliary content 017 overlaid on the electronic content presented in window 002. In other examples, the auxiliary content may be displayed in a separate pane, window, frame, or other construct. In some examples, the auxiliary content is brought into view in an animated fashion from one side of the screen and partially overlaid on top of the presented electronic content that the user is viewing. For example, the auxiliary content may appear to “move\s into place” from one side of a presentation device. In other examples, the auxiliary content may be placed in another window, pane, frame, or the like, which may or may not be juxtaposed, overlaid, or just placed in conjunction with to the initial presented content. Other arrangements are of course contemplated.

FIG. 1D is a block diagram of some example types of gesture based context menu views produced by an example Gesture Based Context Menu System or process. For example, in some embodiments, the model/view/controller aspects of the user interface are separated such that different “views” of the context menu can be utilized with context menu behavior. FIG. 1D shows three different types of context menu views: a pull-down menu 80, a pop-up menu 81, and interest wheels 83 and 85 as described with reference to FIGS. 1A-1C. Menus 80 and 81 are rectangular menus whereas menus 83 and 85 are non-rectangular menus. Other non-rectangular menus can be similarly incorporated.

Example pull-down menu 80 shows a set of default actions for an entity (here represented as <entity> to be filled in by the GBCMS). For example, the “find me a better <entity>” menu item 80a could be used to find a “θbetter” entity where better can be determined from context and/or choices can be presented to the user. The “find me a cheaper <entity>” menu item 80b can be used to initiate comparative shopping or suggest a different source for a pending purchase. The “about <entity>” menu item 80c can be used to present further information to the user about the entity that is the subject of the gesture. The “find like <entity> for me” menu item 80d can be used to find similar entities where similarity is context driven and/or limited or expanded by the set of criteria used. The “Help” menu item 80e can be used to present instructions to the user.

Example pop-up menu 81 shows a different set of default actions for an entity (also represented here as <entity>). For example, the “ship <entity> sooner” menu item 81a can be used to bring up an interface that allows the user to select a faster delivery method, which may be relevant on a e-commerce site. The “cheaper alternative” menu item 81b can be used to initiate comparative shopping or suggest a different source for a pending purchase. The “about <entity>” menu item 81c can be used to present further information to the user about the entity that is the subject of the gesture. The “which friends bought <entitiy>?” menu item 81d can be used to present information related to the user's social network, based on, for example, statistics maintained by an e-commerce site. The “find similar <entity>” menu item 813 can be used to find similar entities where similarity is context driven and/or limited or expanded by the set of criteria used.

Other menu items and/or other types of menus can be similarly incorporated.

FIG. 1E is a block diagram of an example environment for using gesturelets produced by an example Gesture Based Context Menu System (GBCMS) or process. One or more users 10a, 10b, etc. communicate to the GBCMS 110 through one or more networks, for example, wireless and/or wired network 30, by indicating gestures using one or more input devices, for example a mobile device 20a, an audio device such as a microphone 20b, or a pointer device such as mouse 20c or the stylus on table device 20d (or for example, or any other input device, such as a keyboard of a computer device or a human body part, not shown). For the purposes of this description, the nomenclature “*” indicates a wildcard (substitutable letter(s)). Thus, user 20* may indicate a device 20a or a device 20b. The one or more networks 30 may be any type of communications link, including for example, a local area network or a wide area network such as the Internet.

Context menus are typically generated (e.g., defined, produced, instantiated, etc.) “on-the-fly” as a user indicates, by means of a gesture, what portion of the presented content is interesting and a desire to perform related actions. Many different mechanisms for causing a context menu to be generated and presented can be accommodated, for example, a “right-click” of a mouse button following the gesture, a command via an audio input device such as microphone 20b, a secondary gesture, etc.

For example, once the user has provided gestured input, the GBCMS 110 will determine to what area the gesture corresponds and whether the user has indicated a desire to see related actions and/or entities from a context menu. In some embodiments, the GBCMS 110 may take into account other criteria in addition to the indicated area of the presented content in order to determine what context menu to present and/or what menu items are appropriate. The GBCMS 110 determines the indicated area 25 to which the gesture-based input corresponds, and then, based upon the indicated area 25, possibly a set of criteria 50, and based upon a set of action/entity rules 51 generates a context menu. Then, once a menu item is selected from the menu, the GBCMS 110 determines auxiliary content to be presented.

The set of criteria 50 may be dynamically determined, predetermined, local to the GBCMS 110, or stored or supplied externally from the GBCMS 110 as described elsewhere. This set of criteria may include a variety of factors, including, for example: context of the indicated area of the presented content, such as other words, symbols, and/or graphics nearby the indicated area, the location of the indicated area in the presented content, syntactic and semantic considerations, etc; attributes of the user, for example, prior search, purchase, and/or navigation history, demographic information, and the like; attributes of the gesture, for example, direction, size, shape, color, steering, and the like; and other criteria, whether currently defined or defined in the future. In this manner, the GBCMS 110 allows navigation to become “personalized” to the user as much as the system is tuned.

The GBCMS 110 uses the action/entity rules 51 to determine what menu items to place on a context menu. In some embodiments, the rules are used to convert (e.g., generate, make, build, etc.) one or more nouns that relate (e.g., correspond, are associated with, etc.) to the area indicated by the gesture into corresponding verbs. For example, if the indicated area describes a news story about a shop for animal toys, then the noun “shop” may be converted to the verb (e.g. action word, phrase, etc.) “shopping.” This is known as “verbification” or to “verbify.” Similarly, the rules may be used to determine a set of most frequently occurring words that appear close to (e.g., in proximity to, located by, near, etc.) the indicated area and then converting such words into a set of correspond verbs. Also, rules may be presented that enable the GBCMS 110 to determine a set of verbs that are commonly used with one or more entities found within the indicated area. Commonly may refer to most frequent pairings or some other relationship with the entities. For example, if the indicated area is again the news story about a shop for animal toys, then such rules may determine what verbs typically appear used with “shop,” or used with “toys,” or “story,” etc. These rules may search a designated corpus of electronic content to derive the frequent verbs used with data or may search the presented electronic content, or search other bodies of information to derive the data.

In addition, in some embodiments, the action/entity rules 51 may provide one or more default actions to present on context menus. For example, when the GBCMS 110 recognizes that the user is involved in e-commerce (including browsing items and/or services to purchase), the default actions may include some form of buying or shopping, sharing, exploring, and/or obtaining information. In addition, other contexts may lend themselves to default actions such as: find a better <entity>, find a cheaper alternative, ship it sooner, which friends bought <entity>, find similar, and other default actions. The action/entity rules 51 may be implemented in any kind of data storage facility and/or may be provided as instructions such as program code, stored procedures, scripts, and the like.

As explained with reference to FIGS. 1A-1D, the menu items of a context menu are used to determine auxiliary content to be presented. Thus, selection of a menu item often act, in effect, as a navigation tool taking the user to viewing different content. The auxiliary content determined by the GBCMS 110 may be stored local to the GBCMS 110, for example, in auxiliary content data repository 40 associated with a computing system running the GBCMS 110, or may be stored or available externally, for example, from another computing system 42, from third party content 43 (e.g., a 3^{rd} party advertising system, external content, a social network, etc.) from auxiliary content stored using cloud storage 44, from another device 45 (such as from a settop box, A/V component, etc.), from a mobile device connected directly or indirectly with the user (e.g., from a device associated with a social network associated with the user, etc.), and/or from other devices or systems not illustrated. Third party content 43 is demonstrated as being communicatively connected to both the GBCMS 110 directly and/or through the one or more networks 30. Although not shown, various of the devices and/or systems 42-46 also may be communicatively connected to the GBCMS 110 directly or indirectly. The auxiliary content may be any type of content and, for example, may include another document, an image, an audio snippet, an audio visual presentation, an advertisement, an opportunity for commercialization such as a bid, a product offer, a service offer, or a competition, and the like. Once the GBCMS 110 determines the auxiliary content to present, the GBCMS 110 causes the auxiliary content to be presented on a presentation device (e.g., presentation device 20d) associated with the user.

The GBCMS 110 illustrated in FIG. 1E may be executing (e.g., running, invoked, instantiated, or the like) on a client or on a server device or computing system. For example, a client application (e.g., a web application, web browser, other application, etc.) may be executing on one of the presentation devices, such as tablet 20d. In some embodiments, some portion or all of the GBCMS 110 components may be executing as part of the client application (for example, downloaded as a plug-in, active-x component, run as a script or as part of a monolithic application, etc.). In other embodiments, some portion or all of the GBCMS 110 components may be executing as a server (e.g., server application, server computing system, software as a service, etc.) remotely from the client input and/or presentation devices 20a-d.

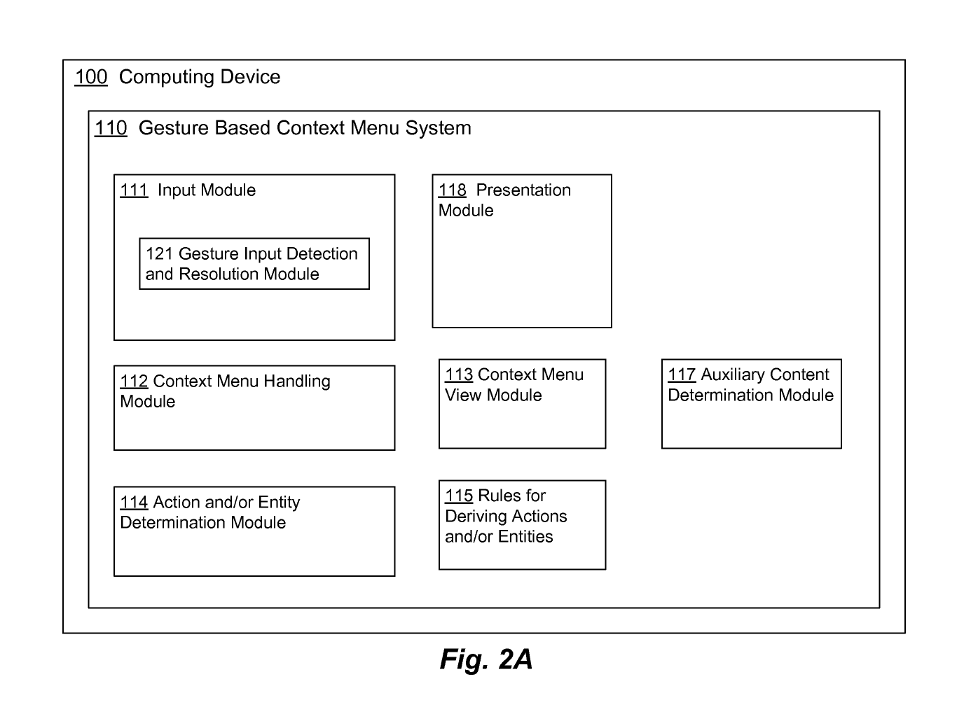

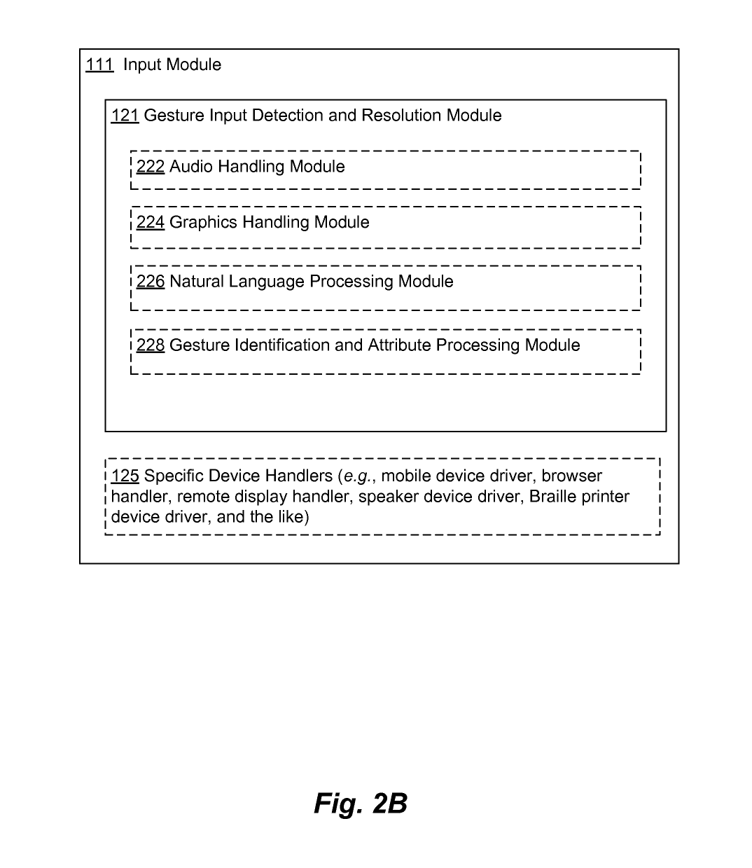

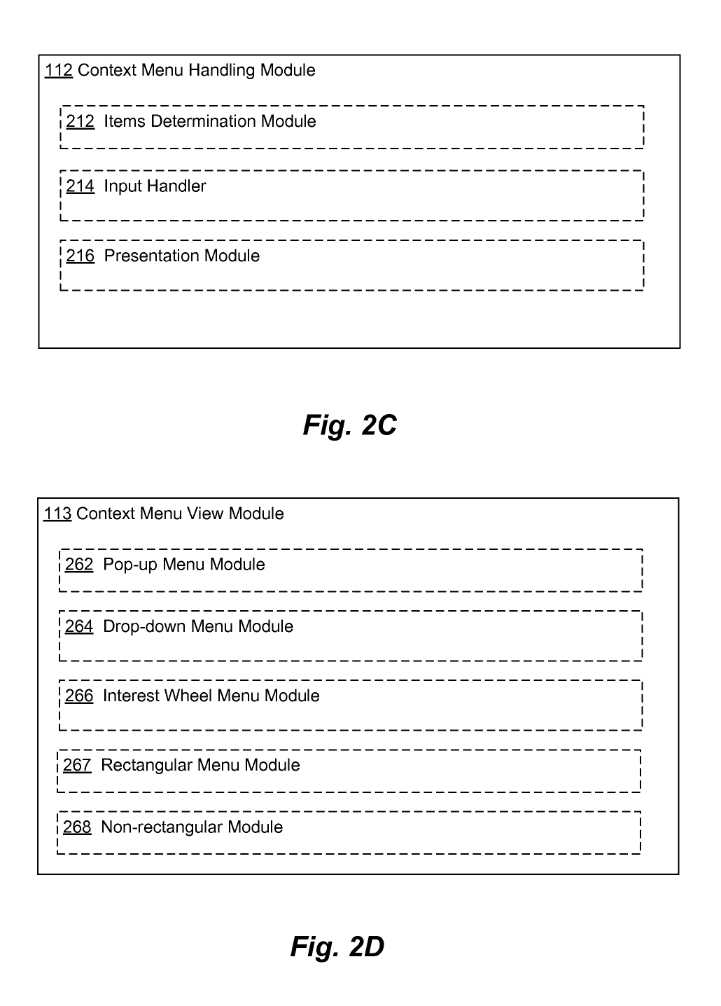

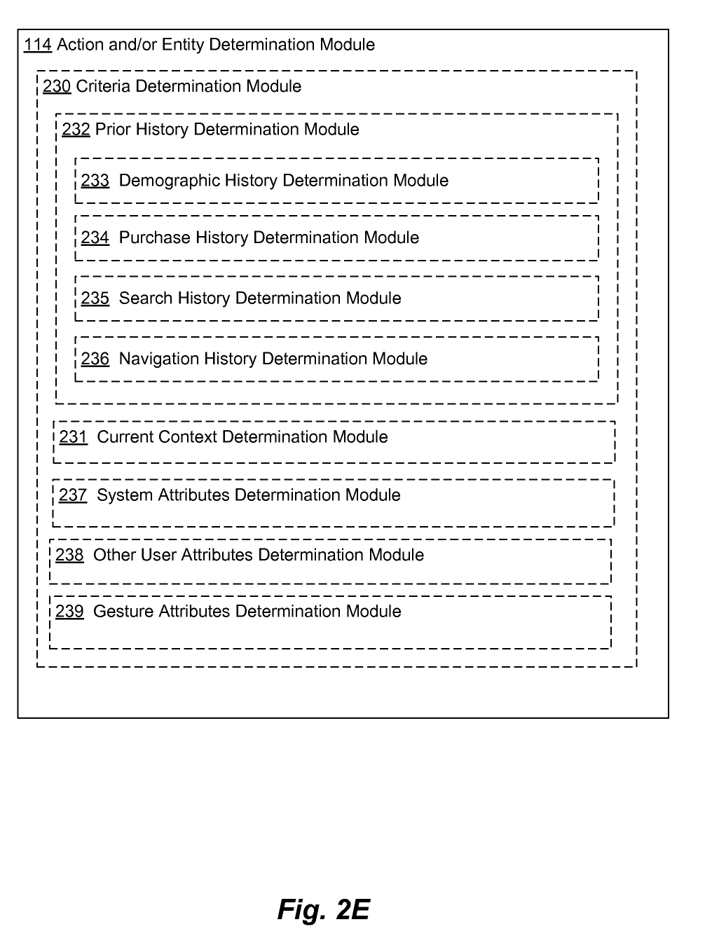

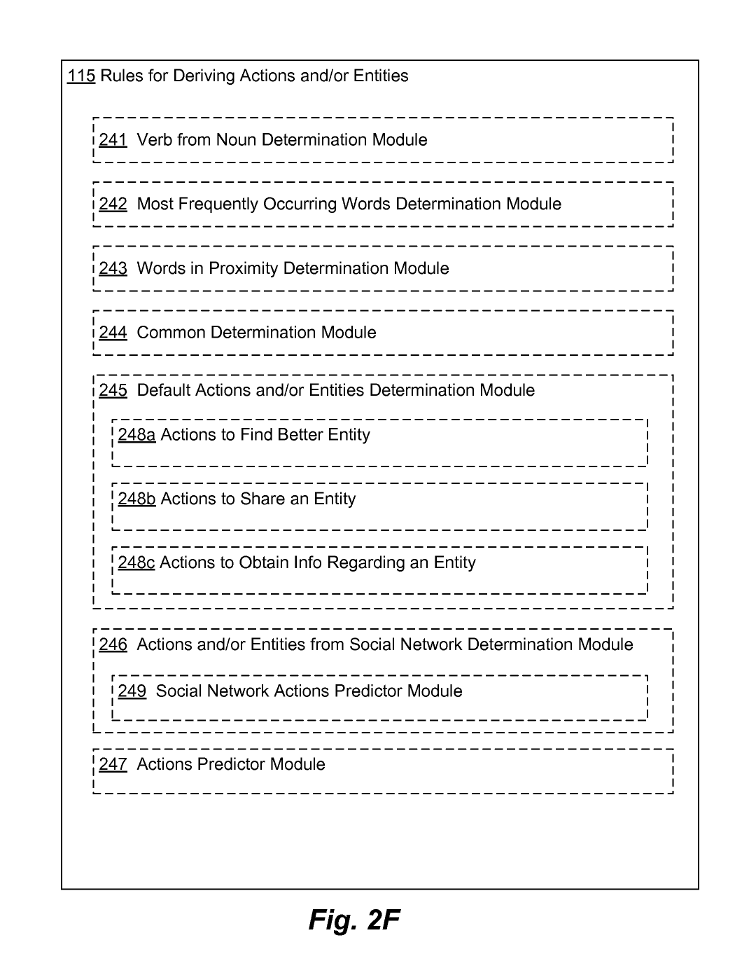

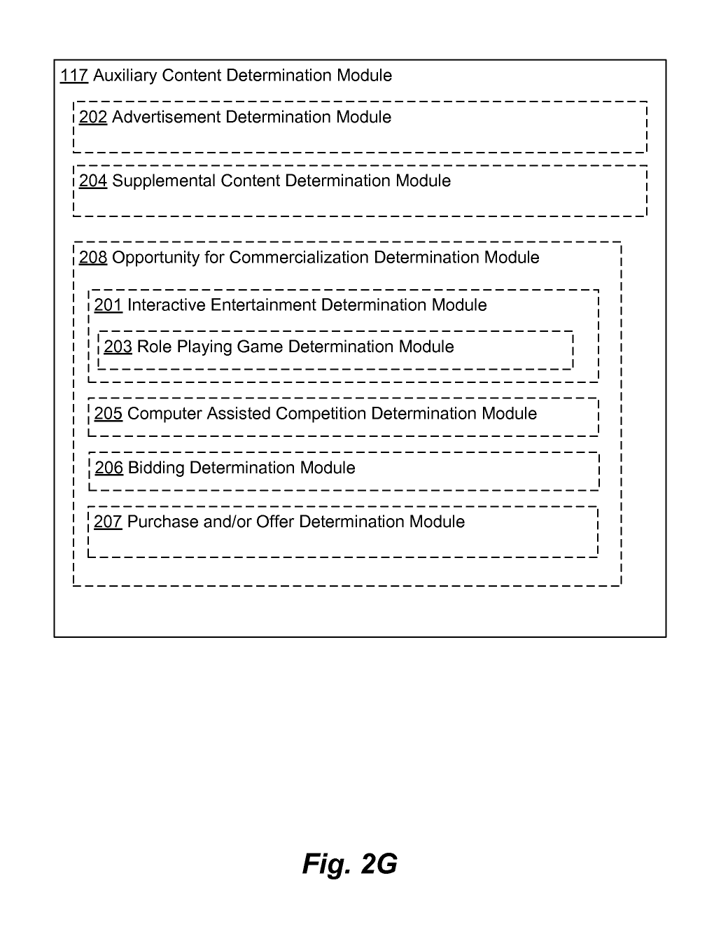

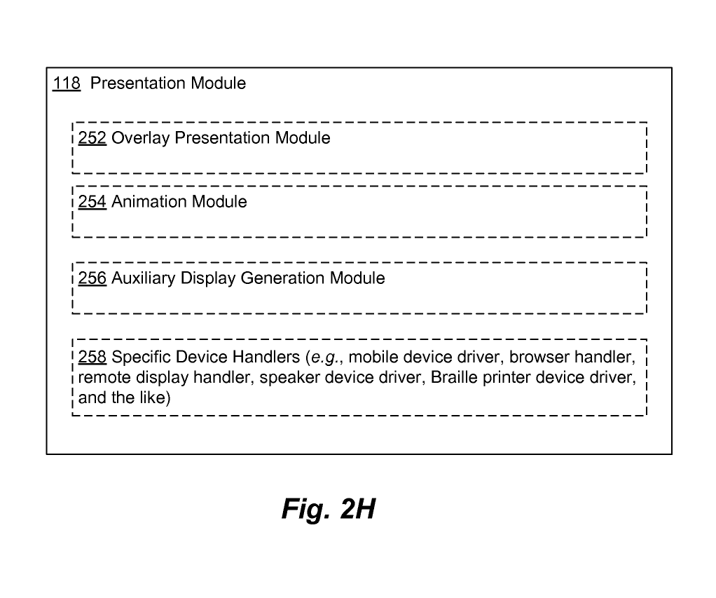

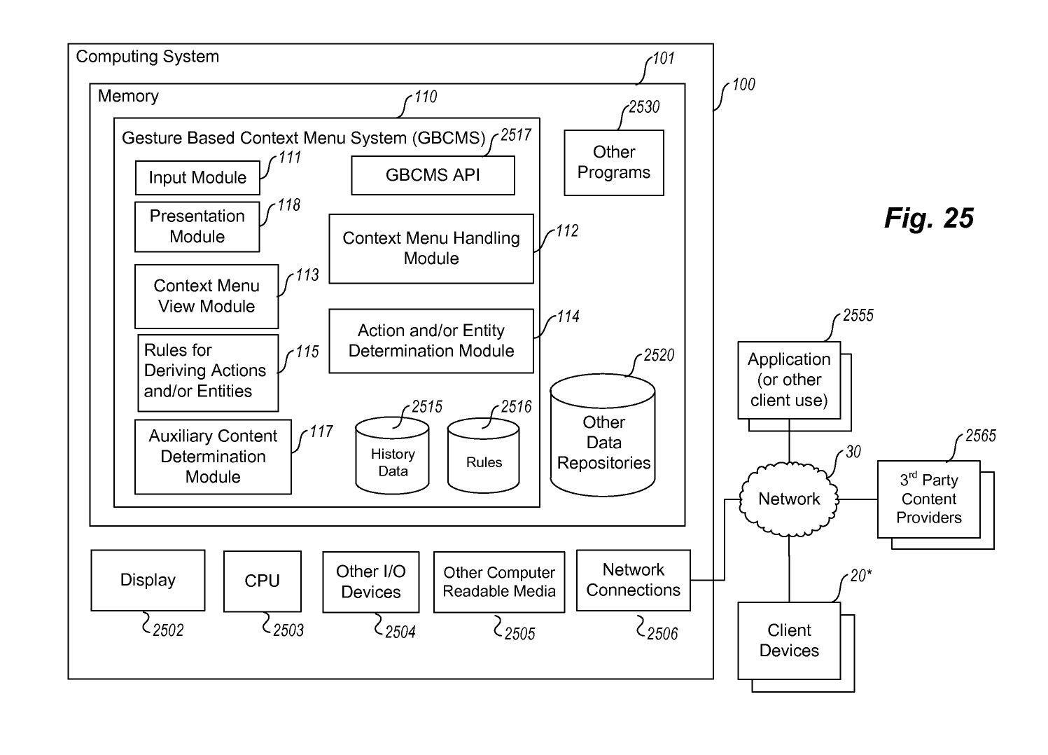

FIG. 2A is an example block diagram of components of an example Gesture Based Context Menu System. In example GBCMSes such as GBCMS 110 of FIG. 1E, the GBCMS comprises one or more functional components/modules that work together to provide gesture based context menus. For example, a Gesture Based Context Menu System 110 may reside in (e.g., execute thereupon, be stored in, operate with, etc.) a computing device 100 programmed with logic to effectuate the purposes of the GBCMS 110. As mentioned, a GBCMS 110 may be executed client side or server side. For ease of description, the GBCMS 110 is described as though it is operating as a server. It is to be understood that equivalent client side modules can be implemented. Moreover, such client side modules need not operate in a client-server environment, as the GBCMS 110 may be practiced in a standalone environment or even embedded into another apparatus. Moreover, the GBCMS 110 may be implemented in hardware, software, or firmware, or in some combination. In addition, although context menus are typically presented on a client presentation device such as devices 20*, the model/view/controller paradigm may be implemented server-side or some combination of both. Details of the computing device/system 100 are described below with reference to FIG. 25.

In an example system, a GBCMS 110 comprises an input module 111, a context menu handling module 112, a context menu view module 113, an action and/or entity determination module 114, rules for deriving actions and/or entities 115, an auxiliary content determination module 117, and a presentation module 117. In some embodiments the GBCMS 110 comprises additional and/or different modules as described further below.

Input module 111 is configured and responsible for determining the gesture and an indication of an area (e.g., a portion) of the presented electronic content indicated by the gesture. In some example systems, the input module 111 comprises a gesture input detection and resolution module 121 to aid in this process. The gesture input detection and resolution module 121 is responsible for determining, using different techniques, for example, pattern matching, parsing, heuristics, etc. to what area a gesture corresponds and what word, phrase, image, clip, etc. is indicated.

Context menu handling module 112 is configured and responsible for determining what context menu to present and the various menu items. As explained, this determination is based upon the context—the area indicated by the gesture and potentially a set of criteria that help to define context. In the MVC (model/view/controller) paradigm, as shown the context menu handling module 112 implements the model and the controller (overall control of the context menus), using the action and/or entity determination module 114 and the rules for deriving actions and/or entities 115 to perform the details. The action and/or entity determination module 114 is configured and responsible for determining what actions and/or entities should be used as menu items based upon context. Thus, it is responsible for figuring out appropriate and relevant context. The rules for deriving actions and/or entities 115 comprise the heuristics (e.g., rules, algorithms, etc.) for figuring out verbs from nouns or other context as described elsewhere. These rules 115 may be implemented as code, data, scripts, stored procedures, and the like. They are shown separately to emphasize that the context menu handling module 112 can operate with any set of such rules. However, the rules 115 and determination module 114 can be substituted in whole or in part as well; they may also be implemented directly as part of the context menu handling module 112.

The context menu handling module 112 also invokes the context menu view module 113 (the view in an MVC paradigm) to implement the type (e.g., the arrangement, presentation, view, or the like) of the context menu. The context menu view module 113 may comprise a variety of implementations corresponding to different types of menus, for example, pop-ups, pull-downs, interest wheels, etc. As a separate module, the context menu view module 113 can easily be replaced and/or supplemented with new or different types of menus. These menu viewers may be defined in advance or even added to the GBCMS 110 once running. Alternatively, the capabilities of the context menu view module 113 may be implemented directly as part of the context menu handling module 112.

Once a context menu is determined and its view identified, the GBCMS 110 uses the presentation module 118 to present the context menu on a device, such as one of client devices 20*. Further in response to user (e.g., user 10*) selection (e.g., choice, invocation, indication, or the like) of a menu item of a presented menu, the context menu handling module 112 invokes the auxiliary content determination module 117 to determine an auxiliary content to present in response to the selection. The GBCMS 110 then forwards (e.g., communicated, sent, pushed, etc.) the auxiliary content to the presentation module 118 to cause the presentation module 118 to present the auxiliary content. The auxiliary content may be presented in a variety of manners, including visual display, audio display, via a Braille printer, etc., and using different techniques, for example, overlays, animation, etc.

FIG. 2B is an example block diagram of further components of the Input Module of an example Gesture Based Context Menu System. In some example systems, the input module 111 may be configured to include a variety of other modules and/or logic. For example, the input module 111 may be configured to include a gesture input detection and resolution module 121 as described with reference to FIG. 2A. The gesture input detection and resolution module 121 may be further configured to include a variety of modules and logic for handling a variety of input devices and systems. For example, gesture input detection and resolution module 121 may be configured to include an audio handling module 222 for handling gesture input by way of audio devices and/or a graphics handling module 224 for handing the association of gestures to graphics in content (such as an icon, image, movie, still, sequence of frames, etc.). In addition, in some example systems, the input module 111 may be configured to include a natural language processing module 226. Natural language processing (NLP) module 226 may be used, for example, to detect whether a gesture is meant to indicate a word, a phrase, a sentence, a paragraph, or some other portion of presented electronic content using techniques such as syntactic and/or semantic analysis of the content. In some example systems, the input module 111 may be configured to include a gesture identification and attribute processing module 228 for handling other aspects of gesture determination such as determining the particular type of gesture (e.g., a circle, oval, polygon, closed path, check mark, box, or the like) or whether a particular gesture is a “steering” gesture that is meant to correct, for example, an initial path indicated by a gesture, a “smudge” which may have its own interpretation, the color of the gesture, for example, if the input device supports the equivalent of a colored “pen” (e.g., pens that allow a user can select blue, black, red, or green), the size of a gesture (e.g., whether the gesture draws a thick or thin line, whether the gesture is a small or large circle, and the like), the direction of the gesture, and/or other attributes of a gesture.

In some example systems, the input module 111 is configured to include a specific device handlers (e.g., drivers) 125 for detecting and controlling input from the various types of input devices, for example devices 20*. For example, specific device handlers 125 may include a mobile device driver, a browser “device” driver, a remote display “device” driver, a speaker device driver, a Braille printer device driver, and the like. The input module 111 may be configured to work with and or dynamically add other and/or different device handlers.

Other modules and logic may be also configured to be used with the input module 111.

FIG. 2C is an example block diagram of further components of the Context Menu Handling Module of an example Gesture Based Context Menu System. In some example systems, the context menu handling module 112 may be configured to include a variety of other modules and/or logic. For example, the context menu handling module 112 may be configured to include an items determination module 212 for determining what menu items to present on a particular menu, an input handler 214 for providing an event loop to detect and handle user selection of a menu item, and a presentation module 215 for determining when and what to present to the user and to determine an auxiliary content to present that is associated with a selection.

FIG. 2D is an example block diagram of further components of the Context Menu View Module of an example Gesture Based Context Menu System. In some example systems, the context menu view module 113 may be configured to include a variety of other modules and/or logic. For example, the context menu view module 113 may be configured to include modules for each menu viewer: for example, a pop-up menu module 262, a drop-down menu module 264, an interest wheel menu module 266, a rectangular menu module 267, a non-rectangular menu module 268 and any other menu viewer modules. The rectangular menu module 267 may be used to implement the pop-up and drop-down modules 262 and 264, respectively, and other types of similar menus.

FIG. 2E is an example block diagram of further components of the Action and/or Entity Determination Module of an example Gesture Based Context Menu System. As described, the action and/or entity determination module 114 is responsible for determining relevant context in order to determine actions and/or entities for menu items. In some example systems, the action and/or entity determination module 114 may be configured to include a variety of other modules and/or logic. For example, the action and/or entity determination module 114 may be configured to include a criteria determination module 230. Based upon this additional criteria, the action and/or entity determination module 114 determines what menu items are appropriate to include.

In some example systems, the criteria determination module 230 may be configured to include a prior history determination module 232, a system attributes determination module 237, other user attributes determination module 238, a gesture attributes determination module 239, and/or current context determination module 231. In some example systems, the prior history determination module 232 determines (e.g., finds, establishes, selects, realizes, resolves, establishes, etc.) prior histories associated with the user and is configured to include modules/logic to implement such. For example, the prior history determination module 232 may be configured to include a demographic history determination module 233 that is configured to determine demographics (such as age, gender, residence location, citizenship, languages spoken, or the like) associated with the user. The prior history determination module 232 may be configured to include a purchase history determination module 234 that is configured to determine a user's prior purchases. The purchase history may be available electronically, over the network, may be integrated from manual records, or some combination. In some systems, these purchases may be product and/or service purchases. The prior history determination module 232 may be configured to include a search history determination module 235 that is configured to determine a user's prior searches. Such records may be stored locally with the GBCMS 110 or may be available over the network 30 or using a third party service, etc. The prior history determination module 232 also may be configured to include a navigation history determination module 236 that is configured to keep track of and/or determine how a user navigates through his or her computing system so that the GBCMS 110 can determine aspects such as navigation preferences, commonly visited content (for example, commonly visited websites or bookmarked items), etc.

The criteria determination module 230 may be configured to include a system attributes determination module 237 that is configured to determine aspects of the “system” that may provide influence or guidance (e.g., may inform) the determination of which menu items are appropriate for the portion of content indicated by the gestured input. These may include aspects of the GBCMS 110, aspects of the system that is executing the GBCMS 119 (e.g., the computing system 100), aspects of a system associated with the GBCMS 110 (e.g., a third party system), network statistics, and/or the like.

The criteria determination module 230 also may be configured to include other user attributes determination module 238 that is configured to determine other attributes associated with the user not covered by the prior history determination module 232. For example, a user's social connectivity data may be determined by module 238.

The criteria determination module 230 also may be configured to include a gesture attributes determination module 239. The gesture attributes determination module 239 is configured to provide determinations of attributes of the gesture input, similar or different from those described relative to input module 111 and gesture attribute processing module 228 for determining to what content a gesture corresponds. Thus, for example, the gesture attributes determination module 239 may provide information and statistics regarding size, length, shape, color, and/or direction of a gesture.

The criteria determination module 230 also may be configured to include a current context determination module 231. The current context determination module 231 is configured to provide determinations of attributes regarding what the user is viewing, the underlying content, context relative to other containing content (if known), whether the gesture has selected a word or phrase that is located with certain areas of presented content (such as the title, abstract, a review, and so forth). Other modules and logic may be also configured to be used with the criteria determination module 230.

FIG. 2F is an example block diagram of further components of the Rules for Deriving Actions and/or Entities of an example Gesture Based Context Menu System. In some example systems, the rules for deriving actions and/or entities 115 (rules) may be configured to include a variety of different modules and logic. For example, the rules 115 may be configured to include one or more algorithms, code, scripts, heuristics, and the like, which may be used to derive (e.g., produce, generate, build, make up, etc.) actions and/or entities. For example, the rules 115 may be configured to include a verb from noun determination module 241 for “verbifying” nouns into verbs (also known as a “verbification” process). Nouns such as “e-mail,” “sleep,” “merge,” and made into verbs through conversion or usage. One way to implement this rule is to store a running list of nouns that can also be used as verbs. This list can also be modified over time.

The rules for deriving actions and/or entities 115 also may be configured to include a most frequently occurring words determination module 242, which is configured to derive the “n” most frequently occurring words across some specified body of content. For example, the most frequently occurring words determination module 242 may review the text of a web page of content presented on a client device 20*, may review the text of a corpus of documents indexed, for example, by an indexer, or may review some designated body of content to count which words appear most frequently in the designated text. Although not shown, a determination module for determining the “n” most frequently occurring images can also be similarly programmed.

The rules for deriving actions and/or entities 115 may also be configured to include a words in proximity determination module 243, which is configured to determine the “n” most frequently occurring words closest to the gestured input. Different logic may be used to set a location range to determine what words are considered sufficiently in proximity to the gestured input.

The rules for deriving actions and/or entities 115 may also be configured to include a common words determination module 244. Similar to the most frequently occurring words determination module 242, this module determines what are the most common words across some specified body of content. Commonality may take into account other factors such as a word's overall (across the corpus) frequency applied to filter out only those frequent words that show up in the electronically presented content. Or, as another example, commonality may take into account the set of criteria to adjudge commonality across a particular group of users. Other logic for determining commonality can be similarly incorporated.

The rules for deriving actions and/or entities 115 may also be configured to include a default actions and/or entities determination module 245 to provide default menu items to populate a context menu. For example, the actions to find better entity module 248a may be configured to include logic that determines “better” entities than one of the entities designated by the gestured indicated area based upon a variety of, possibly programmable, factors, like more expensive, from a more reliable source, having more features, and the like. As another example, the actions to share an entity module 248b may be configured to include logic that populates the context menu with sharing actions to share one of the entities designated by the gestured indicated area such as, emailing the designated entity, sending a link to the designated entity, placing a copy of the designated entity on cloud storage, or the like. Also, as an example, the actions to obtain information regarding an entity module 248c may be configured to include logic that populates the context menu with actions relating to navigating for additional and/or more specific information regarding the designated gestured entity, such as look up in a wiki, show me more detail, define <entity>, and the like. These are of course examples, and other logic may be similarly incorporated.

The rules for deriving actions and/or entities 115 may also be configured to include an actions and/or entities from social network determination module 246, which determines action and/or entities that somehow relate to one or more social networks associated with the user. In one example, this module first determines relevant and/or appropriate social networks and then, based upon the type of social network, populates the context menu with actions that derive from that type of social network. For example, one of the determined actions might be share <entity> with my <social network> friends, which causes the designated entity to automatically insert itself in the correct format on the user's social network on behalf of the user. The actions and/or entities from social network determination module may further be configured to include a social network actions predictor determination module 249 which may be configured to determine relevant and/or appropriate social networks and then, based upon the type of social network, determine what actions users of the that network would include on a context menu given the designated entity, for example, based upon prior history of users in that social network. These are of course examples, and other logic may be similarly incorporated.

The rules for deriving actions and/or entities 115 may also be configured to include an actions predictor module 247 which may be configured to determine what actions other users of the system (or some other designated set of users) would include on a context menu given the designated entity, for example, based upon prior history of other users of the system.

FIG. 2G is an example block diagram of further components of the Auxiliary Content Determination Module of an example Gesture Based Context Menu System. In some example systems, the GBCMS 110 may be configured to include an auxiliary content determination module 117 to determine (e.g., find, establish, select, realize, resolve, establish, etc.) auxiliary or supplemental content for the persistent representation of the gesturelet. The auxiliary content determination module 117 may be further configured to include a variety of different modules to aid in this determination process. For example, the auxiliary content determination module 117 may be configured to include an advertisement determination module 202 to determine one or more advertisements that can be associated with the current gesturelet. For example, as shown in FIG. 1C, these advertisements may be provided by a variety of sources including from local storage, over a network (e.g., wide area network such as the Internet, a local area network, a proprietary network, an Intranet, or the like), from a known source provider, from third party content (available, for example from cloud storage or from the provider's repositories), and the like. In some systems, a third party advertisement provider system is used that is configured to accept queries for advertisements (“ads”) such as using keywords, to output appropriate advertising content.

In some example systems the auxiliary content determination module 117 is further configured to provide a supplemental content determination module 204. The supplemental content determination module 204 may be configured to determine other content that somehow relates to (e.g., associated with, supplements, improves upon, corresponds to, has the opposite meaning from, etc.) the content associated with the gestured area and a selected menu item.

In some example systems the auxiliary content determination module 117 is further configured to provide an opportunity for commercialization determination module 208 to find a commercialization opportunity appropriate for the area indicated by the gesture. In some such systems, the commercialization opportunities may include events such as purchase and/or offers, and the opportunity for commercialization determination module 208 may be further configured to include an interactive entertainment determination module 201, which may be further configured to include a role playing game determination module 203, a computer assisted competition determination module 205, a bidding determination module 206, and a purchase and/or offer determination module 207 with logic to aid in determining a purchase and/or an offer as auxiliary content. Other modules and logic may be also configured to be used with the auxiliary content determination module 117.

FIG. 2H is an example block diagram of further components of the Presentation Module of an example Gesture Based Context Menu System. In some example systems, the presentation module 118 may be configured to include a variety of other modules and/or logic. For example, the presentation module 118 may be configured to include an overlay presentation module 252 for determined how to present auxiliary content determined by the content to present determination module 116 on a presentation device, such as tablet 20d. Overlay presentation module 252 may utilize knowledge of the presentation devices to decide how to integrate the auxiliary content as an “overlay” (e.g., covering up a portion or all of the underlying presented content). For example, when the GBCMS 110 is run as a server application that serves web pages to a client side web browser, certain configurations using “html” commands or other tags may be used.

Presentation module 118 also may be configured to include an animation module 254. In some example systems, the auxiliary content may be “moved in” from one side or portion of a presentation device in an animated manner. For example, the auxiliary content may be placed in a pane (e.g., a window, frame, pane, etc., as appropriate to the underlying operating system or application running on the presentation device) that is moved in from one side of the display onto the content previously shown (a form of navigation to the auxiliary content). Other animations can be similarly incorporated.

Presentation module 118 also may be configured to include an auxiliary display generation module 256 for generating a new graphic or audio construct to be presented in conjunction with the content already displayed on the presentation device. In some systems, the new content is presented in a new window, frame, pane, or other auxiliary display construct.

Presentation module 118 also may be configured to include specific device handlers 258, for example device drivers configured to communicate with mobile devices, remote displays, speakers, Braille printers, and/or the like as described elsewhere. Other or different presentation device handlers may be similarly incorporated.

Also, other modules and logic may be also configured to be used with the presentation module 118.

Although the techniques of a GBCMS are generally applicable to any type of gesture-based system, the phrase “gesture” is used generally to imply any type of physical pointing type of gesture or audio equivalent. In addition, although the examples described herein often refer to online electronic content such as available over a network such as the Internet, the techniques described herein can also be used by a local area network system or in a system without a network. In addition, the concepts and techniques described are applicable to other input and presentation devices. Essentially, the concepts and techniques described are applicable to any environment that supports some type of gesture-based input.

Also, although certain terms are used primarily herein, other terms could be used interchangeably to yield equivalent embodiments and examples. In addition, terms may have alternate spellings which may or may not be explicitly mentioned, and all such variations of terms are intended to be included.

Example embodiments described herein provide applications, tools, data structures and other support to implement a Gesture Based Context Menu System (GBCMS) to be used for providing gesture based context menus. Other embodiments of the described techniques may be used for other purposes. In the following description, numerous specific details are set forth, such as data formats and code sequences, etc., in order to provide a thorough understanding of the described techniques. The embodiments described also can be practiced without some of the specific details described herein, or with other specific details, such as changes with respect to the ordering of the logic or code flow, different logic, or the like. Thus, the scope of the techniques and/or components/modules described are not limited by the particular order, selection, or decomposition of logic described with reference to any particular routine.

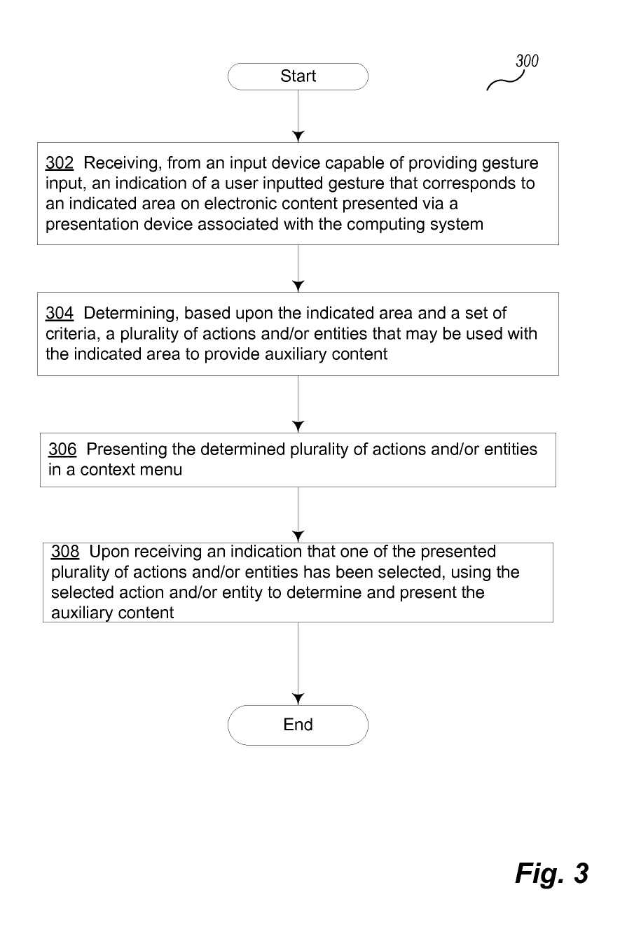

FIGS. 3-23 include example flow diagrams of various example logic that may be used to implement embodiments of a Gesture Based Context Menu System (GBCMS). The example logic will be described with respect to the example components of example embodiments of a GBCMS as described above with respect to FIGS. 1A-2H. However, it is to be understood that the flows and logic may be executed in a number of other environments, systems, and contexts, and/or in modified versions of those described. In addition, various logic blocks (e.g., operations, events, activities, or the like) may be illustrated in a “box-within-a-box” manner. Such illustrations may indicate that the logic in an internal box may comprise an optional example embodiment of the logic illustrated in one or more (containing) external boxes. However, it is to be understood that internal box logic may be viewed as independent logic separate from any associated external boxes and may be performed in other sequences or concurrently.

FIG. 3 is an example flow diagram of example logic for providing a gesture based context menu for providing auxiliary content. Operational flow 300 includes several operations. In operation 302, the logic performs receiving, from an input device capable of providing gesture input, an indication of a user inputted gesture that corresponds to an indicated area of electronic content presented via a presentation device associated with the computing system. This logic may be performed, for example, by the input module 111 of the GBCMS 110 described with reference to FIGS. 2A and 2B by receiving (e.g., obtaining, getting, extracting, and so forth), from an input device capable of providing gesture input (e.g., devices 20*), an indication of a user inputted gesture that corresponds to an indicated area (e.g., indicated area 25) on electronic content presented via a presentation device (e.g., 20*) associated with the computing system 100. One or more of the modules provided by gesture input detection and resolution module 121, including the audio handling module 222, graphics handling module 224, natural language processing module 226, and/or gesture identification and attribute processing module 228 may be used to assist in operation 302.

In operation 304, the logic performs determining, based upon the indicated area and a set of criteria, a plurality of actions and/or entities that may be used with the indicated area to provide auxiliary content. This logic may be performed, for example, by the context menu handling module 112 of the GBCMS 110 described with reference to FIGS. 2A and 2C by generating a set of menu items to present on a context menu, such as the items 80a-80e on the example pop-up context menu 80 shown in FIG. 1D. The generation of the items may be assisted by the items determination module 212 which invokes the action and/or entity determination module 114 to determine information regarding context about the indicated area (e.g., indicated area 25) and the set of criteria and invokes rules from the rules for deriving actions and/or entities 115 to determine what actions and/or entities to present on the context menu.

In operation 306, the logic performs presenting the determined plurality of actions and/or entities in a context menu. This logic may be performed, for example, by the presentation module 215 provided by the context menu handling module 112 of the GBCMS 110 described with reference to FIG. 2C in conjunction with the presentation module 118 of the GBCMS 110 described with reference to FIGS. 2A and 2H to present (e.g., output, display, render, draw, show, illustrate, etc.) the context menu (e.g., a context menu as shown in FIG. 1D).

In operation 308, the logic performs upon receiving an indication that one of the presented plurality of actions and/or entities has been selected, using the selected action and/or entity to determine and present the auxiliary content. This logic may be performed, for example, by the input handler 214 provided by the context menu handling module 112 of the GBCMS 110 to process an indication (e.g., selection, choice, designation, determination, or the like) that a menu item on the context menu has been selected (using for example, a pointer, a microphone, and the like provided by input device 20*). Once the input handler 214 determines the selected action and/or entity, it determines (e.g., obtains, elicits, receives, chooses, picks, designates, indicates, or the like) an auxiliary content to present using, for example the auxiliary content determination module 117 of the GBCMS 110. As is described elsewhere, depending upon the type of content, different additional modules, such as the modules illustrated in FIGS. 2A and 2G, may be utilized to assist in determining the auxiliary content. The context menu handling module 112 then causes the determined auxiliary content (e.g., an advertisement, web page, supplemental content, document, instructions, image, and the like.) to be presented using presentation module 118 of the GBCMS 110.

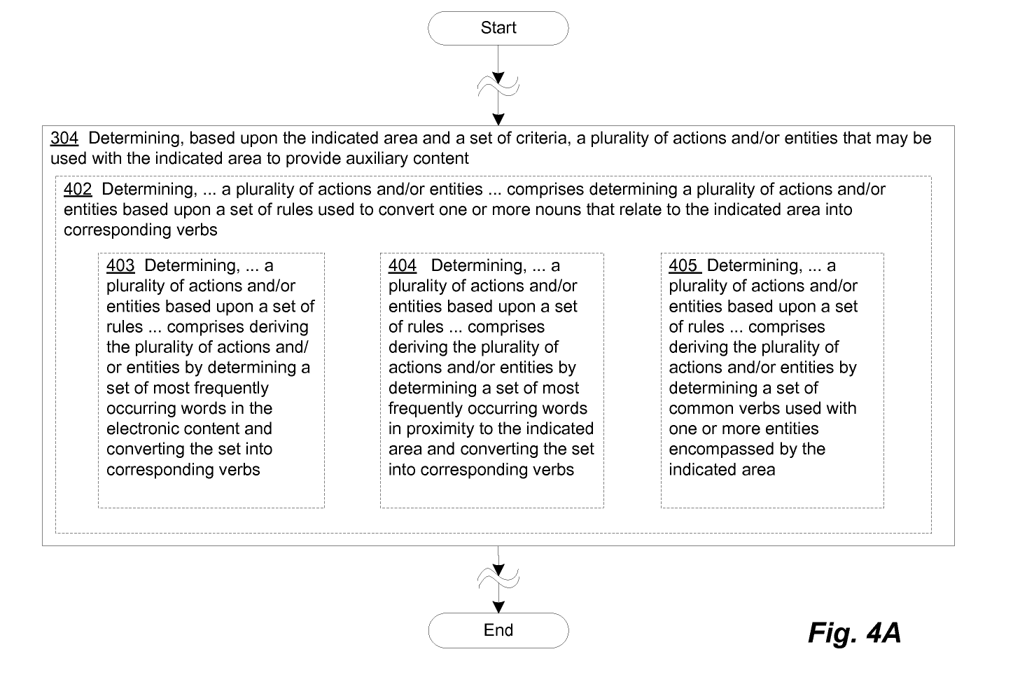

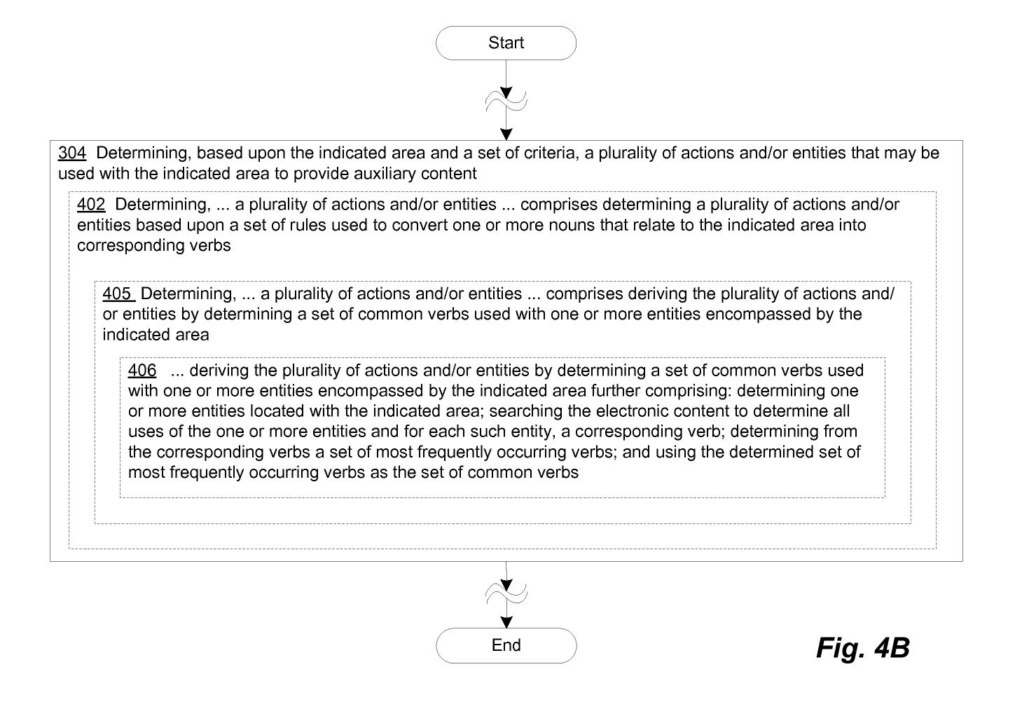

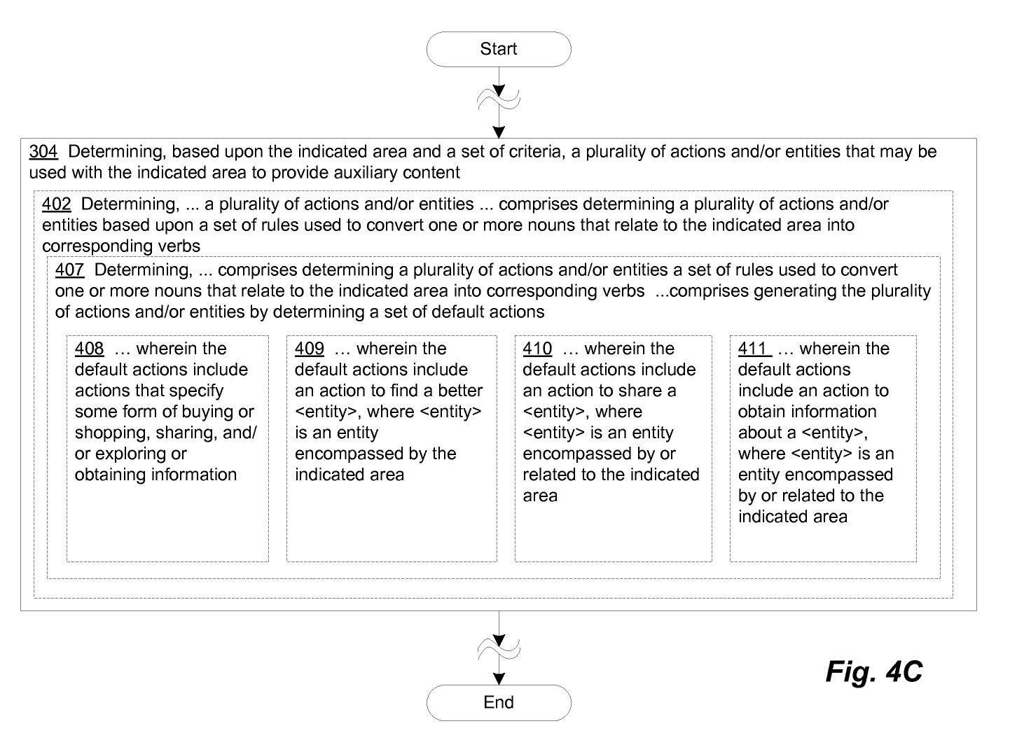

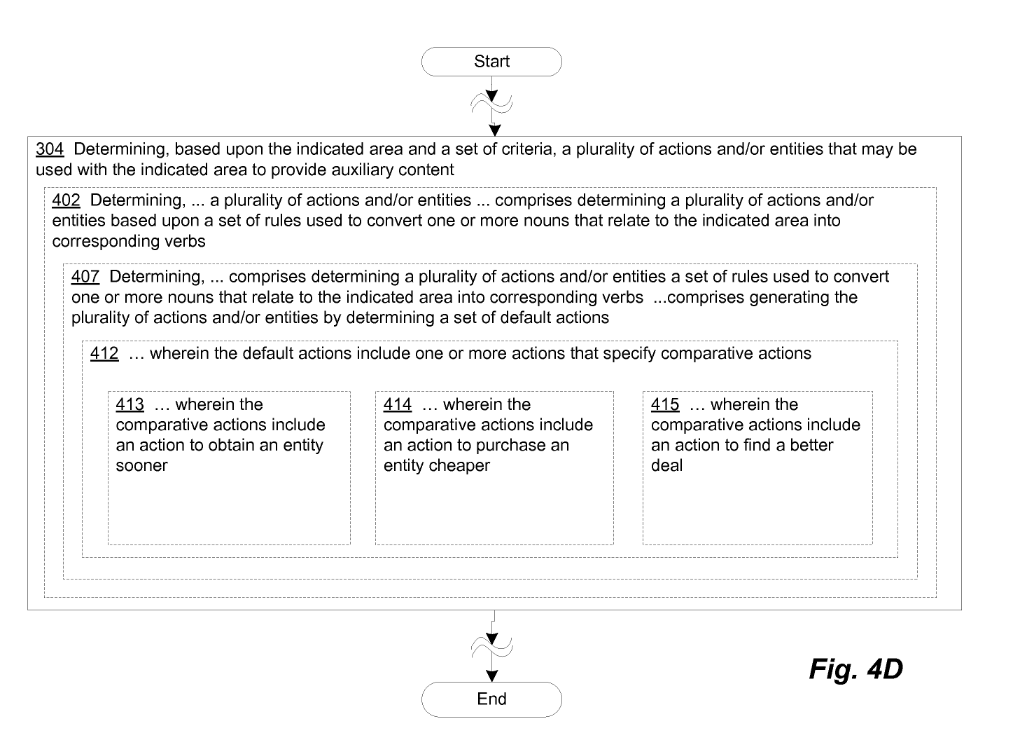

FIG. 4A is an example flow diagram of example logic illustrating various example embodiments of block 304 of FIG. 3. In some embodiments, the logic of operation 304 for determining, based upon the indicated area and a set of criteria, a plurality of actions and/or entities that may be used with the indicated area to provide auxiliary content may include an operation 402 whose logic specifies determining a plurality of actions and/or entities based upon a set of rules used to convert one or more nouns that relate to the indicated area into corresponding verbs. The logic of operation 402 may be performed, for example, by the items determination module 212 provided by the context menu handling module 112 in conjunction with the rules for deriving actions and/or entities 115 of the GBCMS 110 described with reference to FIGS. 2A, 2C and 2F. As explained elsewhere the set of rules may include heuristics for developing verbs (actions) from nouns (entities) encompassed by the area indicated (area 25) by the gestured input.

In some embodiments, operation 402 may further comprise an operation 403 whose logic specifies deriving the plurality of actions and/or entities by determining a set of most frequently occurring words in the electronic content and converting the set into corresponding verbs. The logic of operation 403 may be performed, for example, by the most frequently occurring words determination module 242 and/or the verb from noun determination module 241 of the rules for deriving actions and/or entities 115 GBCMS 110 as described with reference to FIGS. 2A and 2F. For example, the most frequent “n” occurring words in the presented electronic content may be counted and converted into verbs (actions) through a process known as verbification.

In the same or different embodiments, operation 402 may include an operation 404 whose logic specifies deriving the plurality of actions and/or entities by determining a set of most frequently occurring words in proximity to the indicated area and converting the set into corresponding verbs. The logic of operation 404 may be performed, for example, by the words in proximity determination module 243 and/or the verb from noun determination module 241 of the rules for deriving actions and/or entities 115 GBCMS 110 as described with reference to FIGS. 2A and 2F. For example, the “n” occurring words in proximity to the indicated area (area 25) of the presented electronic content may be used and/or converted into verbs (actions) through a process known as verbification.

In the same or different embodiments, operation 402 may include an operation 405 whose logic specifies deriving the plurality of actions and/or entities by determining a set of common verbs used with one or more entities encompassed by the indicated area. The logic of operation 404 may be performed, for example, by the common words determination module 244 and/or the verb from noun determination module 241 of the rules for deriving actions and/or entities 115 GBCMS 110 as described with reference to FIGS. 2A and 2F. For example, the most common words in relative to some designated body of content may be used and/or converted into verbs (actions) through a process known as verbification.

FIG. 4B is an example flow diagram of example logic illustrating various example embodiments of block 304 of FIG. 3. In some embodiments, the logic of operation 304 for determining, based upon the indicated area and a set of criteria, a plurality of actions and/or entities that may be used with the indicated area to provide auxiliary content may include an operation 402 for determining a plurality of actions and/or entities based upon a set of rules used to convert one or more nouns that relate to the indicated area into corresponding verbs which may include an operation 405 for deriving the plurality of actions and/or entities by determining a set of common verbs used with one or more entities encompassed by the indicated area as described in FIG. 4A. In some embodiments, the operation 405 may further include operation 406 whose logic specifies determining one or more entities located with the indicated area;

searching the electronic content to determine all uses of the one or more entities and for each such entity, a corresponding verb;

determining from the corresponding verbs a set of most frequently occurring verbs; and

using the determined set of most frequently occurring verbs as the set of common verbs. The logic of operation 406 may be performed, for example, by the common words determination module 244 and/or the verb from noun determination module 241 of the rules for deriving actions and/or entities 115 GBCMS 110 as described with reference to FIGS. 2A and 2F. For example, in one embodiment, each indicated word in the indicated area (e.g., indicated area 25) that is an entity is examined (e.g., looked at, analyzed, etc.) and then the electronic content analyzed to determine all of the verbs used with this entity (e.g., elsewhere in the content). This verb list is then used as the set of common verbs.

FIG. 4C is an example flow diagram of example logic illustrating various example embodiments of block 304 of FIG. 3. In some embodiments, the logic of operation 304 for determining, based upon the indicated area and a set of criteria, a plurality of actions and/or entities that may be used with the indicated area to provide auxiliary content may include an operation 402 for determining a plurality of actions and/or entities based upon a set of rules used to convert one or more nouns that relate to the indicated area into corresponding verbs as described in FIG. 4A. In some embodiments, operation 402 may further comprise an operation 407 whose logic specifies generating the plurality of actions and/or entities by determining a set of default actions. The logic of operation 407 may be performed, for example, by the default actions and/or entities determination module 245 of the rules for deriving actions and/or entities 115 of the GBCMS 110 described in FIGS. 2A and 2F. Default actions may be defaults such as “share,” “buy,” “get info,” or may be more context dependent.

In some embodiments, the operation 407 may include operation 408 whose logic specifies wherein the default actions include actions that specify some form of buying or shopping, sharing, exploring and/or obtaining information. The logic of operation 408 may be performed, for example, by any one or more of the modules of the default actions and/or entities determination module 245 of the rules for deriving actions and/or entities 115 of the GBCMS 110 described in FIGS. 2A and 2F. For example, actions for “buy <entity,” “obtain more info on <entity,” or the like may be derived by this logic.

In the same or different embodiments, the operation 407 may include operation 409 whose logic specifies wherein the default actions include an action to find a better <entity>, where <entity> is an entity encompassed by the indicated area. The logic of operation 409 may be performed, for example, by the actions to find better entity module 248a provided by the default actions and/or entities determination module 245 provided by the rules for deriving actions and/or entities 115 of the GBCMS 110 described in FIGS. 2A and 2F. Rules for determining what is “better” may be context dependent such as, for example, brighter color, better quality photograph, more often purchased, or the like. Different heuristics may be programmed into the logic to thus derive a better entity.

In the same or different embodiments, the operation 407 may include operation 410 whose logic specifies wherein the default actions include an action to share a <entity>, where <entity> is an entity encompassed by or related to the indicated area. The logic of operation 410 may be performed, for example, by the actions to share an entity module 248b provided by the default actions and/or entities determination module 245 provided by the rules for deriving actions and/or entities 115 of the GBCMS 110 described in FIGS. 2A and 2F. Sharing (e.g., forwarding, emailing, posting, messaging, or the like) may be also enhanced by context determined by the indicated area (area 25) or the set of criteria (e.g., prior search or purchase history, type of gesture, or the like).

In the same or different embodiments, the operation 407 may include operation 411 whose logic specifies wherein the default actions include an action to obtain information about a <entity>, where <entity> is an entity encompassed by or related to the indicated area. The logic of operation 410 may be performed, for example, by the actions to obtain information regarding an entity module 248c provided by the default actions and/or entities determination module 245 provided by the rules for deriving actions and/or entities 115 of the GBCMS 110 described in c. Obtaining information may suggest actions like “find more information,” “get details,” “find source,” “define,” or the like.

FIG. 4D is an example flow diagram of example logic illustrating various example embodiments of block 304 of FIG. 3. In some embodiments, the logic of operation 304 for determining, based upon the indicated area and a set of criteria, a plurality of actions and/or entities that may be used with the indicated area to provide auxiliary content may include an operation 402 for determining a plurality of actions and/or entities based upon a set of rules used to convert one or more nouns that relate to the indicated area into corresponding verbs, which may include as operation 407 for generating the plurality of actions and/or entities by determining a set of default actions as described with reference to FIG. 4C. In some embodiments, operation 407 may further include operation 412, whose logic specifies the default actions include one or more actions that specify comparative actions. The logic of operation 412 may be performed, for example, by one or more of the modules of the default actions and/or entities determination module 245 provided by rules for deriving actions and/or entities 115 of the GBCMS 110 as described in FIGS. 2A and 2F. For example, comparative actions may include verb phrases such as “find me a better,” “find me a cheaper,” “ship me sooner,” or the like.

In the same or other embodiments, operation 407 may include operation 413, whose logic specifies the comparative actions include an action to obtain an entity sooner. The logic of operation 413 may be performed, for example, by one or more of the modules of the default actions and/or entities determination module 245 provided by rules for deriving actions and/or entities 115 of the GBCMS 110 as described in FIGS. 2A and 2F. For example, obtain an entity sooner may include shipping sooner, subscribing faster, finishing quicker, or the like.

In the same or other embodiments, operation 407 may include operation 414, whose logic specifies the comparative actions include an action to purchase an entity cheaper. The logic of operation 414 may be performed, for example, by one or more of the modules of the default actions and/or entities determination module 245 provided by rules for deriving actions and/or entities 115 of the GBCMS 110 as described in FIGS. 2A and 2F. For example, an action to purchase an entity cheaper may include presenting alternative web sites, shipping carriers, etc. to enable a user to find a better price for one or more entities designated by the indicated area.

In the same or other embodiments, operation 407 may include operation 415, whose logic specifies the comparative actions include an action to find a better deal. The logic of operation 415 may be performed, for example, by one or more of the modules of the default actions and/or entities determination module 245 provided by rules for deriving actions and/or entities 115 of the GBCMS 110 as described in FIGS. 2A and 2F. For example, an action to find a better deal may include presenting alternative web sites, shipping carriers, etc. to enable a user to find a better price or better quality for the price of one or more entities designated by the indicated area.

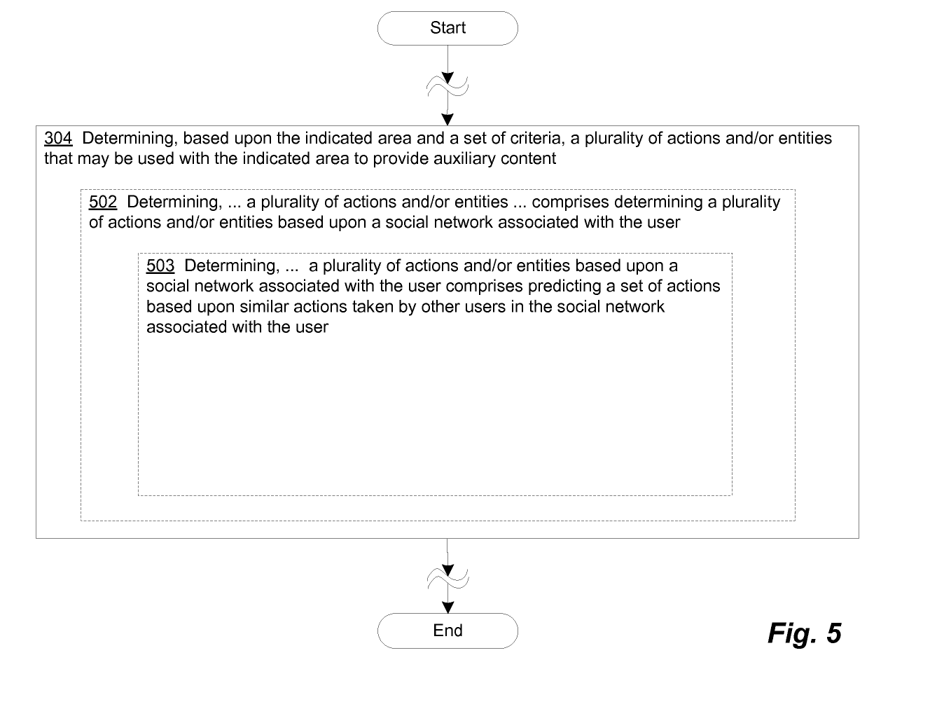

FIG. 5 is an example flow diagram of example logic illustrating various example embodiments of block 304 of FIG. 3. In some embodiments, the logic of operation 304 for determining, based upon the indicated area and a set of criteria, a plurality of actions and/or entities that may be used with the indicated area to provide auxiliary content may include an operation 502 whose logic specifies determining a plurality of actions and/or entities based upon a social network associated with the user. The logic of operation 502 may be performed, for example, by the actions and/or entities from social network determination module 246 provided by rules for deriving actions and/or entities 115 of the GBCMS 110 as described in FIGS. 2A and 2F. Determining actions and/or entities based upon a social network may include identifying at least one social network of relevance to the user and determining (e.g. selecting, surmising, generating, etc.) what actions might be relevant within that network environment.

In the same or different embodiments, operation 502 may further include an operation 503 whose logic specifies predicting a set of actions based upon similar actions taken by other users in the social network associated with the user. The logic of operation 503 may be performed, for example, by the social network actions predictor determination module 249 provided by the actions and/or entities from social network determination module 246 provided by rules for deriving actions and/or entities 115 of the GBCMS 110 as described in FIGS. 2A and 2F. Predicting actions based upon a social network may include identifying at least one social network of relevance to the user and determining (e.g. selecting, surmising, generating, etc.) what actions other users may perform (maybe with respect to an entity within the gestured indicated area) within that network environment.

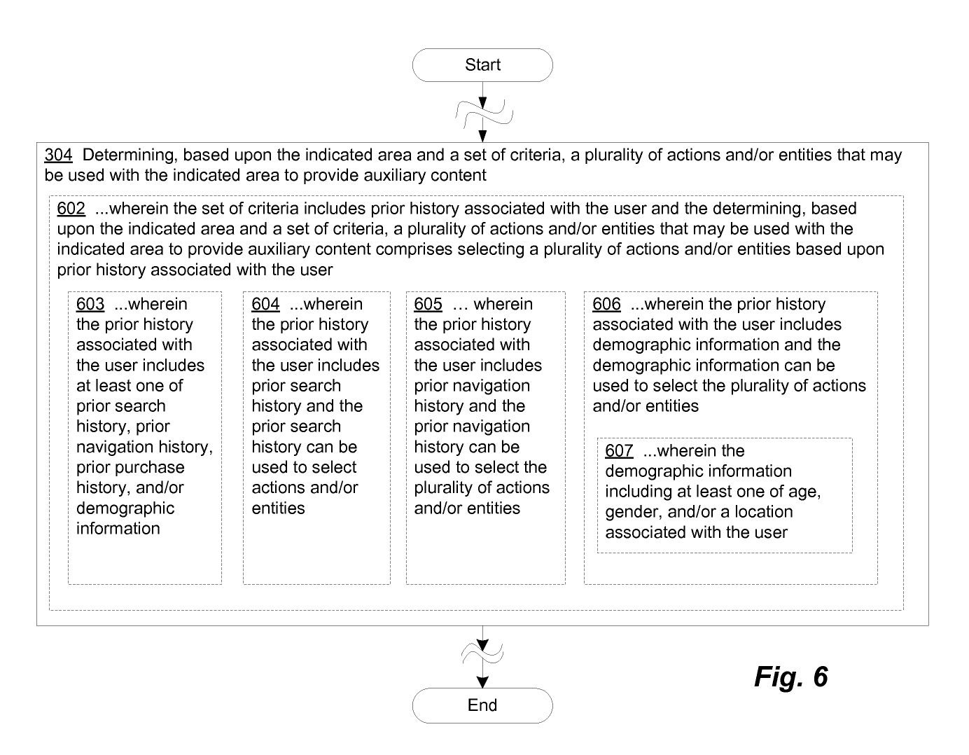

FIG. 6 is an example flow diagram of example logic illustrating various example embodiments of block 304 of FIG. 3. In some embodiments, the logic of operation 304 for determining, based upon the indicated area and a set of criteria, a plurality of actions and/or entities that may be used with the indicated area to provide auxiliary content may include an operation 602 whose logic specifies selecting a plurality of actions and/or entities based upon prior history associated with the user. The logic of operation 602 may be performed, for example, by the prior history determination module 232 of the criteria determination module 230 provided by the action and/or entity determination module 114 of the GBCMS 110 described with reference to FIGS. 2A and 2E to determine a set of criteria (e.g., factors, aspects, and the like) based upon some kind of prior history associated with the user (e.g., prior purchase history, navigation history, and the like).

In some embodiments, operation 601 may further include operation 603 whose logic specifies wherein the prior history associated with the user includes at least one of prior search history, prior navigation history, prior purchase history, and/or demographic information. The logic of operation 603 may be performed, for example, by the various modules of the prior history determination module 232 of the criteria determination module 230 provided by the action and/or entity determination module 114 of the GBCMS 110 described with reference to FIGS. 2A and 2E to determine a specific type of history associated with the user.

In some embodiments, operation 602 may include operation 604 whose logic specifies wherein the prior history associated with the user includes prior search history and the prior search history can be used to select actions and/or entities. The logic of operation 604 may be performed, for example, by the search history determination module 235 of the prior history determination module 232 of the criteria determination module 230 provided by the action and/or entity determination module 114 of the GBCMS 110 described with reference to FIGS. 2A and 2E to determine search history associated with the user. For example, information regarding the prior web pages visited by the user in response to a search command (e.g., such as a “Bing” “Yahoo” or “Google” search) may be provided by this process. Factors such as what particular content the user has reviewed and searched for may be considered. Other factors may be considered as well.

In the same or different embodiments, operation 602 may include operation 605 whose logic specifies wherein the prior history associated with the user includes prior navigation history and the prior navigation history can be used to select the plurality of actions and/or entities. The logic of operation 605 may be performed, for example, by the navigation history determination module 236 of the prior history determination module 232 of the criteria determination module 230 provided by the action and/or entity determination module 114 of the GBCMS 110 described with reference to FIGS. 2A and 2E to determine navigation history associated with the user. For example, factors such as what content the user has reviewed, for how long, and where the user has navigated to from that point may be considered. Other factors may be considered as well., for example, what types of web pages were navigated to, the sources, and the like.

In the same or different embodiments, operation 602 may include operation 606 whose logic specifies wherein the prior history associated with the user includes demographic information and the demographic information can be used to select the plurality of actions and/or entities. The logic of operation 606 may be performed, for example, by the demographic history determination module 233 of the prior history determination module 232 of the criteria determination module 230 provided by the action and/or entity determination module 114 of the GBCMS 110 described with reference to FIGS. 2A and 2E to determine demographic information associated with the user. Factors such as what the age, gender, location, citizenship, religious preferences (if specified) may be considered. Other factors may be considered as well.

In the some embodiments, operation 606 may further include an operation 607 whose logic specifies the demographic information including at least one of age, gender, and/or a location associated with the user. The logic of operation 607 may be performed, for example, by the demographic history determination module 233 of the prior history determination module 232 of the criteria determination module 230 provided by the action and/or entity determination module 114 of the GBCMS 110 described with reference to FIGS. 2A and 2E to determine age, gender, and/or a location associated with the user, such as where the user resides. Location may include any location associated with the user included a residence, a work location, a home town, a birth location, and so forth. This allows menu items of a context menu to be targeted to the particulars of a user. Other factors may be considered as well.

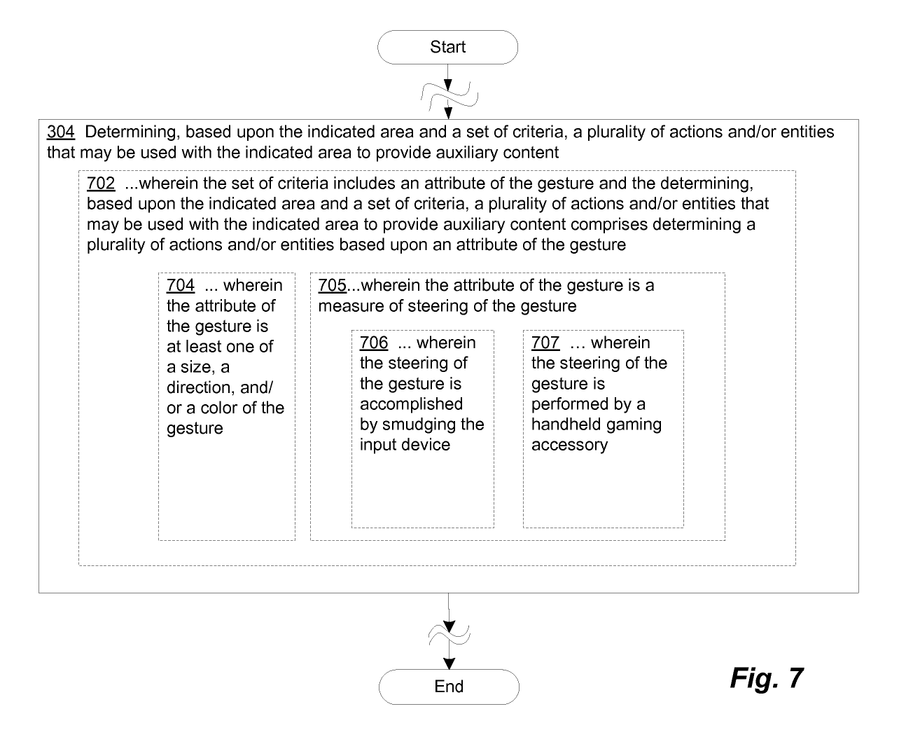

FIG. 7 is an example flow diagram of example logic illustrating various example embodiments of block 304 of FIG. 3. In some embodiments, the logic of operation 304 for determining, based upon the indicated area and a set of criteria, a plurality of actions and/or entities that may be used with the indicated area to provide auxiliary content may include an operation 702 whose logic specifies determining a plurality of actions and/or entities based upon an attribute of the gesture. The logic of operation 702 may be performed, for example, by gesture attributes determination module 239 provided by the criteria determination module 230 of the action and/or entity determination module 114 of the GBCMS 110 described with reference to FIGS. 2A and 2E to determine context related information from the attributes of the gesture itself (e.g., color, size, direction, shape, and so forth).

In the same or different embodiments, operation 702 may include an operation 704 whose logic specifies the attribute of the gesture is at least one of a size, a direction, and/or a color of the gesture. The logic of operation 704 may be performed, for example, gesture attributes determination module 239 provided by the criteria determination module 230 of the action and/or entity determination module 114 of the GBCMS 110 described with reference to FIGS. 2A and 2E to determine context related information from the attributes of the gesture such as size, direction, color, shape, and so forth. Size of the gesture may include, for example, width and/or length, and other measurements appropriate to the input device 20*. Direction of the gesture may include, for example, up or down, east or west, and other measurements appropriate to the input device 20*. Color of the gesture may include, for example, a pen and/or ink color as well as other measurements appropriate to the input device 20*.

In the same or different embodiments, operation 702 may include an operation 705 whose logic specifies the attribute of the gesture is a measure of steering of the gesture. The logic of operation 705 may be performed, for example, by gesture attributes determination module 239 provided by the criteria determination module 230 of the action and/or entity determination module 114 of the GBCMS 110 as described with reference to FIGS. 2A and 2E to determine (e.g., retrieve, designate, resolve, etc.) context related information from the attributes of the gesture such as steering. Steering of the gesture may occur when, for example, an initial gesture is indicated (e.g., on a mobile device) and the user desires to correct or nudge it in a certain direction.

In the some embodiments, operation 705 may further include an operation 706 whose logic specifies that the steering of the gesture is accomplished by smudging the input device. The logic of operation 706 may be performed, for example, by the gesture attributes determination module 239 provided by the criteria determination module 230 of the action and/or entity determination module 114 of the GBCMS 110 as described with reference to FIGS. 2A and 2E to determine context related information from the attributes of the gesture such as smudging. Smudging of the gesture may occur when, for example, an initial gesture is indicated (e.g., on a mobile device) and the user desires to correct or nudge it in a certain direction by, for example “smudging” the gesture using for example, a finger. This type of action may be particularly useful on a touch screen input device.

In the same or different embodiments, operation 705 may include an operation 707 whose logic specifies the steering of the gesture is performed by a handheld gaming accessory. The logic of operation 706 may be performed, for example, by the gesture attributes determination module 239 provided by the criteria determination module 230 of the action and/or entity determination module 114 of the GBCMS 110 as described with reference to FIGS. 2A and 2E to determine context related information steering information associated with the gesture attributes. In this case the steering is performed by a handheld gaming accessory such as a particular type of input device 20*.

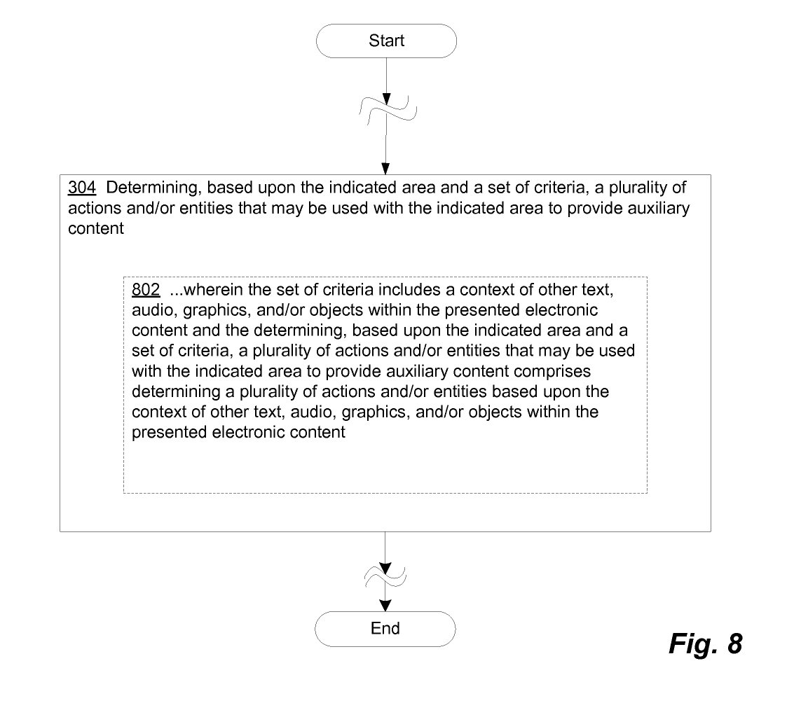

FIG. 8 is an example flow diagram of example logic illustrating various example embodiments of block 304 of FIG. 3. In some embodiments, the logic of operation 304 for determining, based upon the indicated area and a set of criteria, a plurality of actions and/or entities that may be used with the indicated area to provide auxiliary content may include an operation 802 whose logic specifies determining a plurality of actions and/or entities based upon the context of other text, audio, graphics, and/or objects within the presented electronic content. The logic of operation 802 may be performed, for example, by the current context determination module 231 provided by the criteria determination module 230 of the action and/or entity determination module 114 of the GBCMS 110 as described with reference to FIGS. 2A and 2E to determine context related information from attributes of the electronic content.

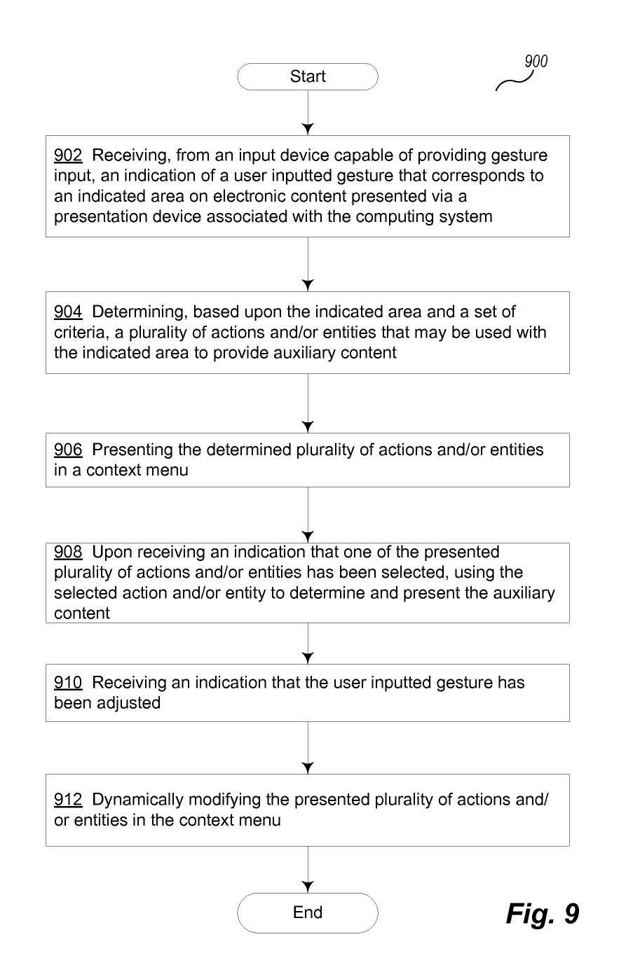

FIG. 9 is an example flow diagram of example logic illustrating an alternative embodiment for providing a gesture based context menu for providing auxiliary content. The logic of FIG. 9 includes, as a portion, the logic included in FIG. 3. In particular, the logic described by operations 902, 904, 906, and 908 follows that of corresponding operations in FIG. 3. In addition, operational flow 900 includes several additional operations. In particular, operational flow 900 includes an operation 910 for receiving an indication that the user inputted gesture has been adjusted. The logic of operation 910 may be performed, for example, by the input module 111 of the GBCMS 110 described with reference to FIG. 2A by receiving (e.g., obtaining, getting, extracting, and so forth), from an input device capable of providing gesture input (e.g., devices 20*), an indication that the user inputted gesture has been adjusted (e.g., moved, changed in size and/or direction, and the like) in some manner. One or more of the modules provided by gesture input detection and resolution module 121, including the audio handling module 222, graphics handling module 224, natural language processing module 226, and/or gesture identification and attribute processing module 228 may be used to assist in operation 910.

In operation 912, the logic performs dynamically modifying the presented plurality of actions and/or entities in the context menu. The logic of operation 912 may be performed, for example, by the presentation module 215 provided by the context menu handling module 112 of the GBCMS 110 described with reference to FIG. 2C in conjunction with the presentation module 118 of the GBCMS 110 described with reference to FIG. 2H to present (e.g., output, display, render, draw, show, illustrate, etc.) the changes (e.g., additions, replacements, subtractions, rewording, new links, or the like) to the context menu (e.g., a context menu as shown in FIG. 1D).

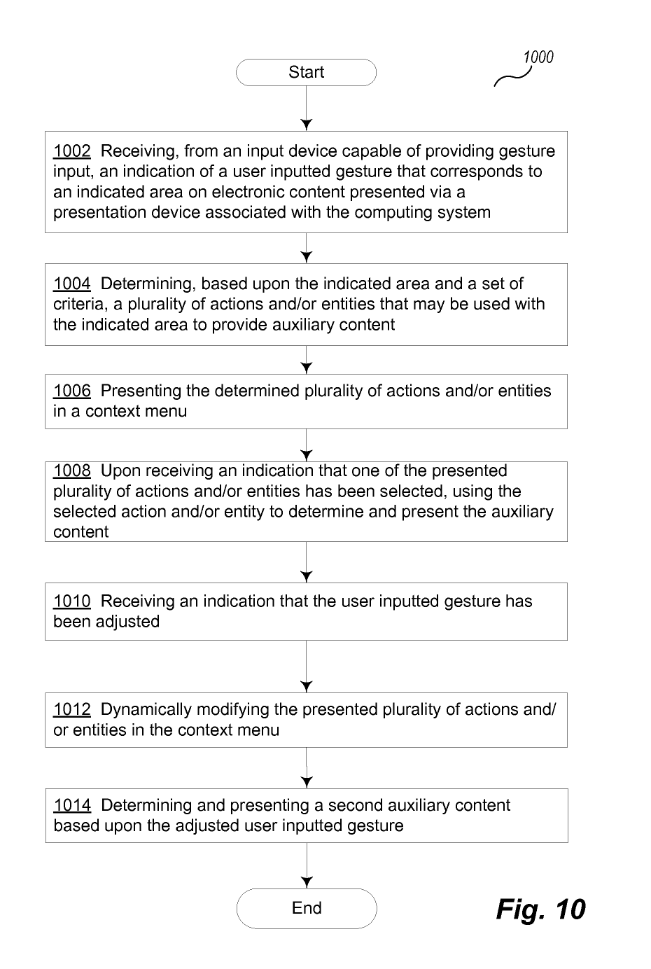

FIG. 10 is an example flow diagram flow diagram of example logic illustrating an alternative embodiment for providing a gesture based context menu for providing auxiliary content. The logic of FIG. 10 includes, as a portion, the logic included in FIG. 9. In particular, the logic described by operations 1002, 1004, 1006, 1008, 1010 and 1012 follows that of corresponding operations in FIG. 9. In addition, operational flow 1000 includes an operation 1014 which performs determining and presenting a second auxiliary content based upon the adjusted user inputted gesture. The logic of operation 1014 may be performed, for example, by the auxiliary content determination module 117 of the GBCMS 110 as described with reference to FIGS. 2A and 2G. As is described elsewhere, depending upon the type of content, different additional modules, such as the modules illustrated in FIG. 2G, may be utilized to assist in determining the auxiliary content. The context menu handling module 112 then causes the determined auxiliary content (e.g., an advertisement, web page, supplemental content, document, instructions, image, and the like.) to be presented using presentation module 118 of the GBCMS 110 as described with reference to FIGS. 2A and 2H.

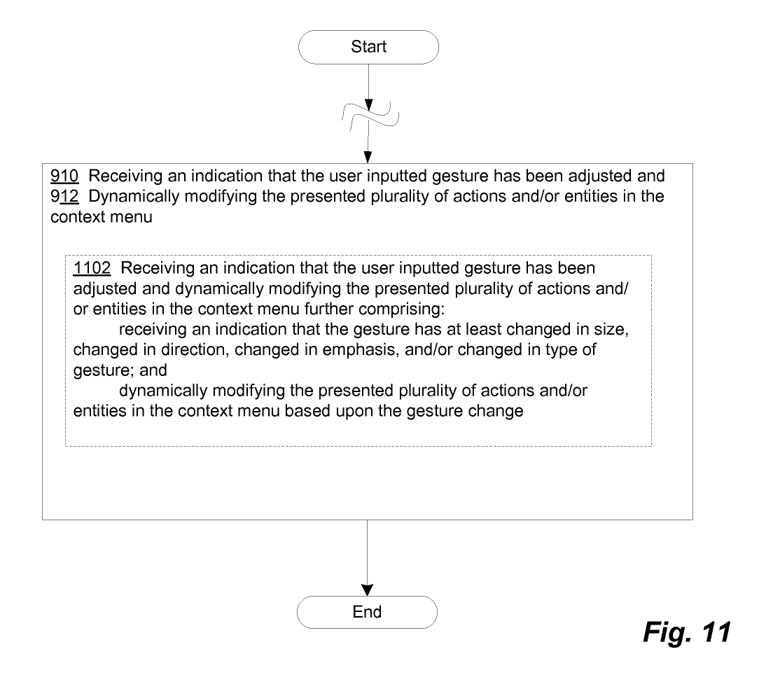

FIG. 11 is an example flow diagram of example logic illustrating an example embodiment of block 910 and 912 of FIG. 9. The logic of operations 910 and 912 for receiving an indication that the user inputted gesture has been adjusted and for dynamically modifying the presented plurality of actions and/or entities in the context menu may include several additional operations. In particular, the logic of operation 910 and 912 may include operation 1102 whose logic specifies receiving an indication that the gesture has at least changed in size, changed in direction, changed in emphasis, and/or changed in type of gesture; and dynamically modifying the presented plurality of actions and/or entities in the context menu based upon the gesture change. The logic of operation 1102 may be performed, for example, by the input module 111 of the GBCMS 110 described with reference to FIG. 2A by receiving an indication that the user inputted gesture has been adjusted (e.g., moved, changed in size and/or direction, and the like) in some manner and by the presentation module 215 provided by the context menu handling module 112 of the GBCMS 110 described with reference to FIG. 2C in conjunction with the presentation module 118 of the GBCMS 110 described with reference to FIGS. 2A and 2H to present (e.g., output, display, render, draw, show, illustrate, etc.) the changes (e.g., additions, replacements, subtractions, rewording, new links, or the like) to the context menu (e.g., a context menu as shown in FIG. 1D). One or more of the modules provided by gesture input detection and resolution module 121, including the audio handling module 222, graphics handling module 224, natural language processing module 226, and/or gesture identification and attribute processing module 228 may be used to assist in operation 1102.

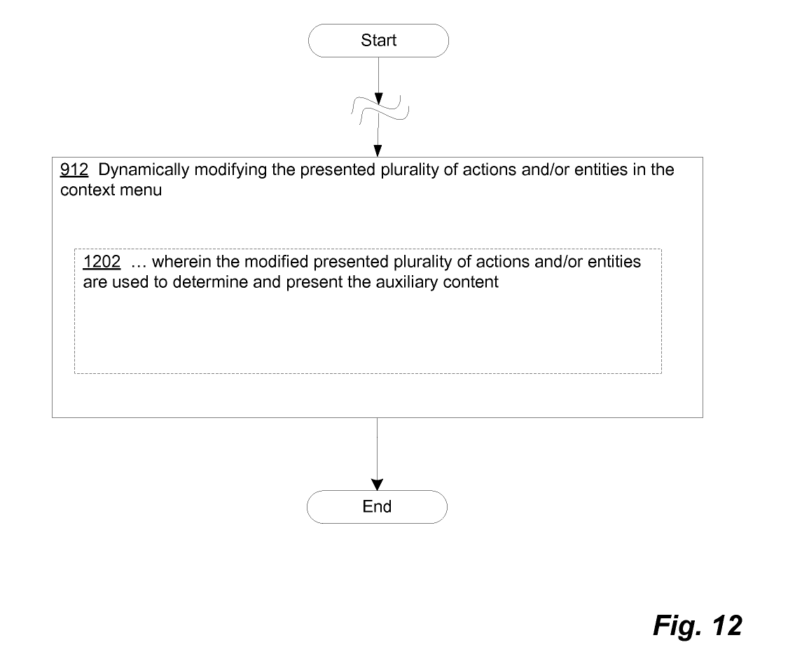

FIG. 12 is an example flow diagram of example logic illustrating an example embodiment of block 912 of FIG. 9. The logic of operation 912 for dynamically modifying the presented plurality of actions and/or entities in the context menu may include an operation 1202 whose logic specifies wherein the modified presented plurality of actions and/or entities are used to determine and present the auxiliary content. The logic of operation 1202 may be performed, for example, by the auxiliary content determination module 117 of the GBCMS 110 as described with reference to FIGS. 2A and 2G. As is described elsewhere, depending upon the type of content, different additional modules, such as the modules illustrated in FIG. 2G, may be utilized to assist in determining the auxiliary content. The context menu handling module 112 then causes the determined auxiliary content (e.g., an advertisement, web page, supplemental content, document, instructions, image, and the like.) to be presented using presentation module 118 of the GBCMS 110 as described with reference to FIGS. 2A and 2H.

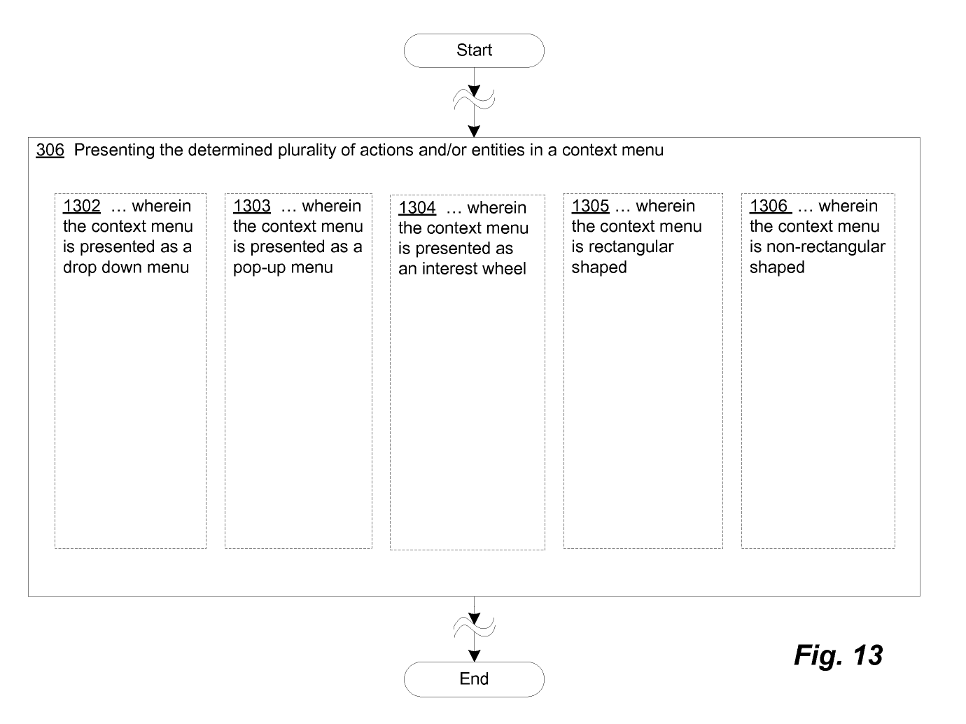

FIG. 13 is an example flow diagram of example logic illustrating various example embodiments of block 306 of FIG. 3. The logic of operation 306 for presenting the determined plurality of actions and/or entities in a context menu may include an operation 1302 whose logic specifies that the context menu is presented as a drop down menu. The logic of operation 1302 may be performed, for example, by the drop-down menu module 264 of the context menu view module 113 provided by of the GBCMS 110 as described with reference to FIGS. 2A and 2D. Drop-down context menus may contain, for example, any number of actions and/or entities that are determined to be menu items. They appear visible with a standard user interface typically from the point of a “cursor,” “pointer,” or other reference associated with the gesture.

In some embodiments, operation 306 may include an operation 1303 whose logic specifies that the context menu is presented as a pop-up menu. The logic of operation 1303 may be performed, for example, by the pop-up menu module 262 of the context menu view module 113 provided by of the GBCMS 110 as described with reference to FIGS. 2A and 2D. Pop-up menus may be implemented, for example, using overlay windows, dialog boxes, and the like, and appear visible with a standard user interface typically from the point of a “cursor,” “pointer,” or other reference associated with the gesture.

In the same or different embodiments, operation 306 may include an operation 1304 whose logic specifies that the context menu is presented as a an interest wheel. The logic of operation 1303 may be performed, for example, by interest wheel menu module 266 of the context menu view module 113 provided by of the GBCMS 110 as described with reference to FIGS. 2A and 2D. In one embodiment, an interest wheel has menu items arranged in a pie shape, similar to the menu items displayed in FIG. 1D.

In the same or different embodiments, operation 306 may include an operation 1305 whose logic specifies that the context menu is rectangular shaped. The logic of operation 1305 may be performed, for example, by the rectangular menu module 267 provided by the context menu view module 113 provided by of the GBCMS 110 as described with reference to FIGS. 2A and 2D. Rectangular menus may include pop-ups and pull-downs, although they may also be implemented in a non-rectangular fashion.

In the same or different embodiments, operation 306 may include an operation 1306 whose logic specifies that the context menu is rectangular shaped. The logic of operation 1306 may be performed, for example, by the non-rectangular menu module 268 provided by the context menu view module 113 provided by of the GBCMS 110 as described with reference to FIGS. 2A and 2D. Non-rectangular menus may include pop-ups, pull-downs, and interest wheels. They may also include other viewer controls not shown in FIG. 1D.

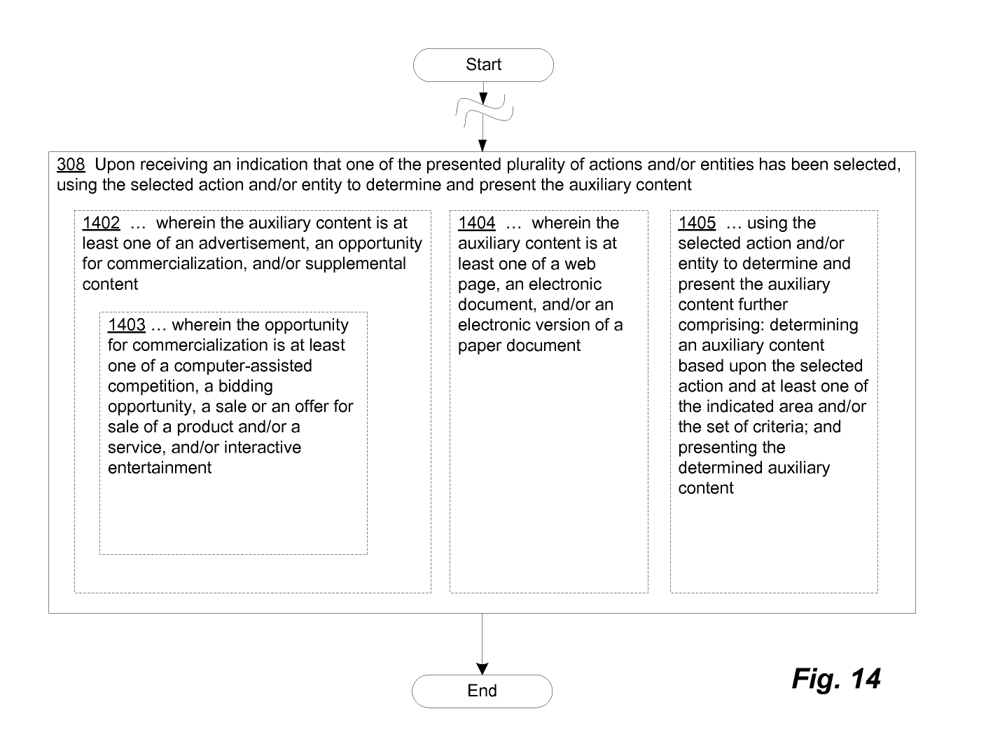

FIG. 14 is an example flow diagram of example logic illustrating various example embodiments of block 308 of FIG. 3. The logic of operation 308 for upon receiving an indication that one of the presented plurality of actions and/or entities has been selected, using the selected action and/or entity to determine and present the auxiliary content may include an operation 1402 whose logic specifies that the auxiliary content is at least one of an advertisement, an opportunity for commercialization, and/or supplemental content. The logic of operation 1402 may be performed, for example, by one or more of the modules provided by the auxiliary content determination module 117 of the GBCMS 110 as described with reference to FIGS. 2A and 2G. For example, advertisements may be provided by the logic of the advertisement determination module 202, opportunities for commercialization may be provided by the opportunity for commercialization determination module 208 or its modules, and/or supplemental content may be provided by the supplemental content determination module 204.

In some embodiments, operation 1402 may further include an operation 1403 whose logic specifies the auxiliary content is at least one of a computer-assisted competition, a bidding opportunity, a sale or an offer for sale of a product and/or a service, and/or interactive entertainment. The logic of operation 1403 may be performed, for example, by the various modules of the opportunity for commercialization determination module 208 provided by the auxiliary content determination module 117 of the GBCMS 110 as described with reference to FIGS. 2A and 2G. For example, the auxiliary content may provide access to a website that allows a computer game or other interactive entertainment via the role playing game determination module 203 or the interactive entertainment determination module 201 provided by the auxiliary content determination module 117 of the GBCMS 110 as described with reference to FIG. 2G. The interactive entertainment may include, for example, a computer game, an on-line quiz show, a lottery, a movie to watch, and so forth. Also, a computer assisted competition could be outside of the computing system as long as it is somehow assisted by a computer. A sale or an offer for sale of a product and/or a service could involve any type of information or item, online or offline. In addition, a service may be any type of service including a computer representation of the human generated service, for example, a contract or a calendar reminder.

In the same or different embodiments, operation 308 may include operation 1404 whose logic specifies that the auxiliary content is at least one of a web page, an electronic document, and/or an electronic version of a paper document. The logic of operation 1404 may be performed, for example, by the auxiliary content determination module 117 of the GBCMS 110 as described with reference to FIGS. 2A and 2G.

In the same or different embodiments, operation 308 may include operation 1405 whose logic specifies that determining an auxiliary content based upon the selected action and at least one of the indicated area and/or the set of criteria and presenting the determined auxiliary content. The logic of operation 1405 may be performed, for example, by the input handler 214, which, once it determines the selected action and/or entity, it determines (e.g., obtains, elicits, receives, chooses, picks, designates, indicates, or the like) an auxiliary content to present using, for example the auxiliary content determination module 117 of the GBCMS 110. As is described elsewhere, depending upon the type of content, different additional modules, such as the modules illustrated in FIGS. 2A and 2G, may be utilized to assist in determining the auxiliary content. The context menu handling module 112 then causes the determined auxiliary content (e.g., an advertisement, web page, supplemental content, document, instructions, image, and the like.) to be presented using presentation module 118 of the GBCMS 110. The presentation module 118 is responsible for presenting the auxiliary content.

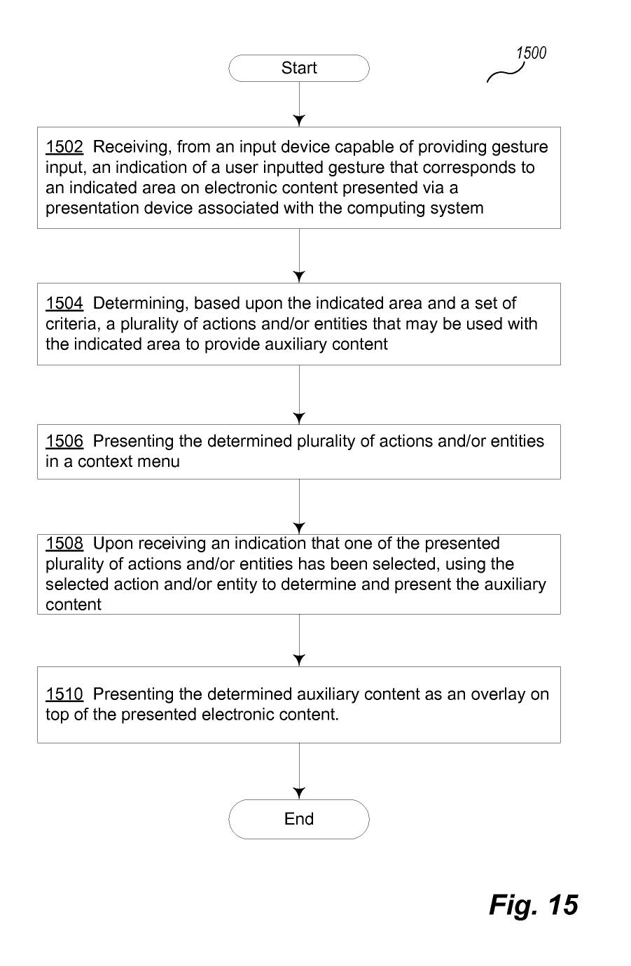

FIG. 15 is an example flow diagram of example logic illustrating an alternative embodiment for providing a gesture based context menu for providing auxiliary content. The logic of FIG. 15 includes, as a portion, the logic included in FIG. 3. In particular, the logic described by operations 1502, 1504, 1506, and 1508 follows that of corresponding operations in FIG. 3. In addition, operational flow 1500 includes an operation 1510 for presenting the determined auxiliary content as an overlay on top of the presented electronic content. The logic of operation 1510 may be performed, for example, by the overlay presentation module 252 provided by the presentation module 118 of the GBCMS 110 as described with reference to FIGS. 2A and 2H. In some embodiments, the overlay may be implemented as a pop-up window, a frame, a pane, a separate panel, or the like. It may overlay the underlying presented electronic content partially or totally.

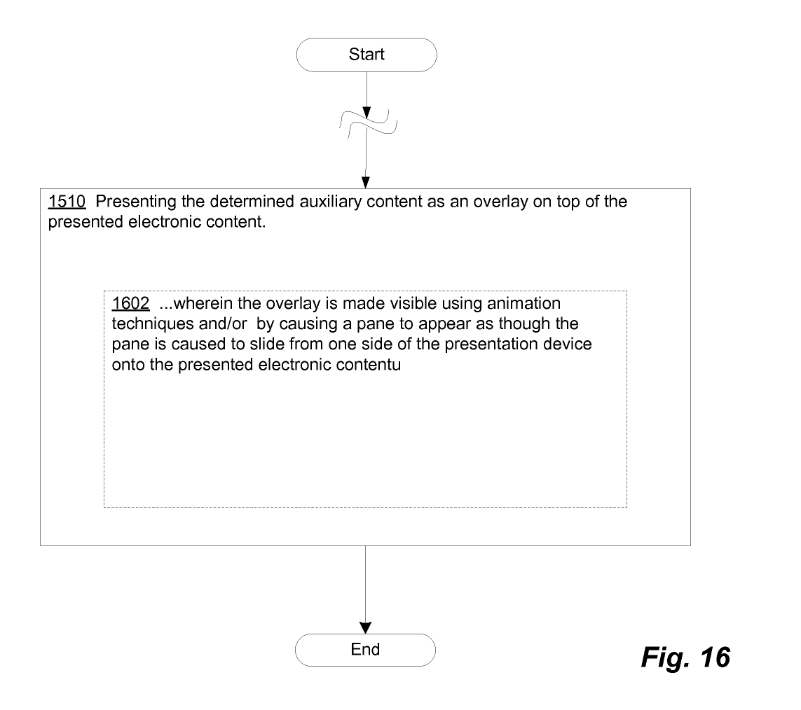

FIG. 16 is an example flow diagram of example logic illustrating an example embodiment of block 1510 of FIG. 15. The logic of operation 1510 for presenting the determined auxiliary content as an overlay on top of the presented electronic content may include an operation 1602 whose logic specifies that the determining an auxiliary content based upon the selected action and at least one of the indicated area and/or the set of criteria is made visible using animation techniques and/or by causing a pane to appear as though the pane is caused to slide from one side of the presentation device onto the presented electronic content. The logic of operation 1602 may be performed, for example, by overlay presentation module 252 provided by the presentation module 118 of the GBCMS 110 including use of the animation module 254 as described with reference to FIGS. 2A and 2H. The animation techniques may be make the pane appear as though it is “flying” in, “sliding in,” “jumping in,” or any other type of animation.

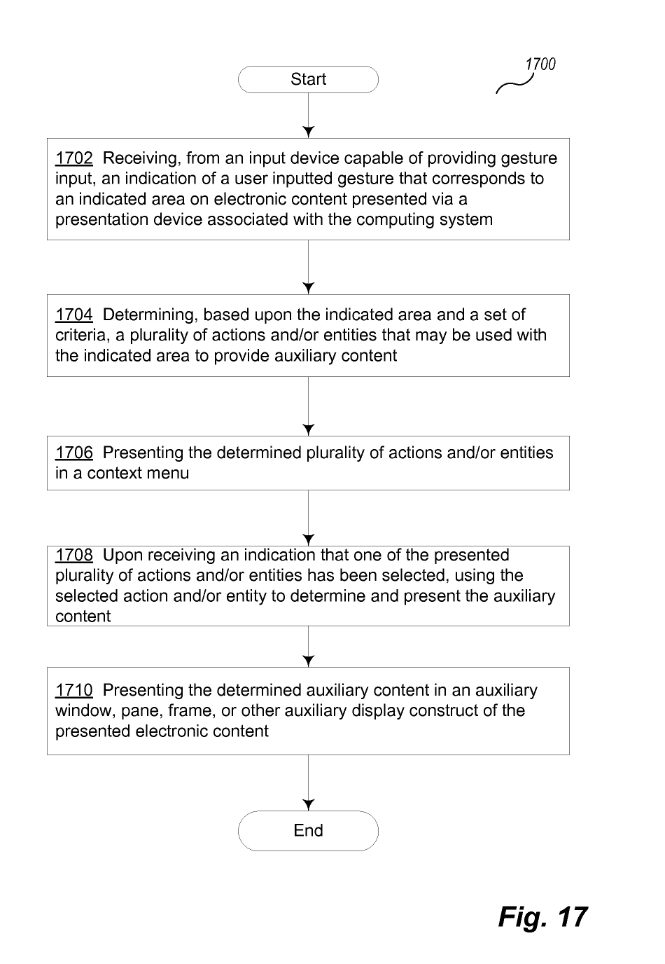

FIG. 17 is an example flow diagram of example logic illustrating an alternative embodiment for providing a gesture based context menu for providing auxiliary content. The logic of FIG. 17 includes, as a portion, the logic included in FIG. 3. In particular, the logic described by operations 1702, 1704, 1706, and 1708 follows that of corresponding operations in FIG. 3. In addition, operational flow 1700 includes an operation 1710 for presenting the determined auxiliary content in an auxiliary window, pane, frame, or other auxiliary display construct of the presented electronic content. The logic of operation 1710 may be performed, for example, by auxiliary display generation module 256 provided by the presentation module 118 of the GBCMS 110 as described in FIGS. 2A and 2H. The auxiliary content may be presented in an auxiliary construct to allow the user (user 10*) to continue to view and/or operate on the contents of the presented electronic content.

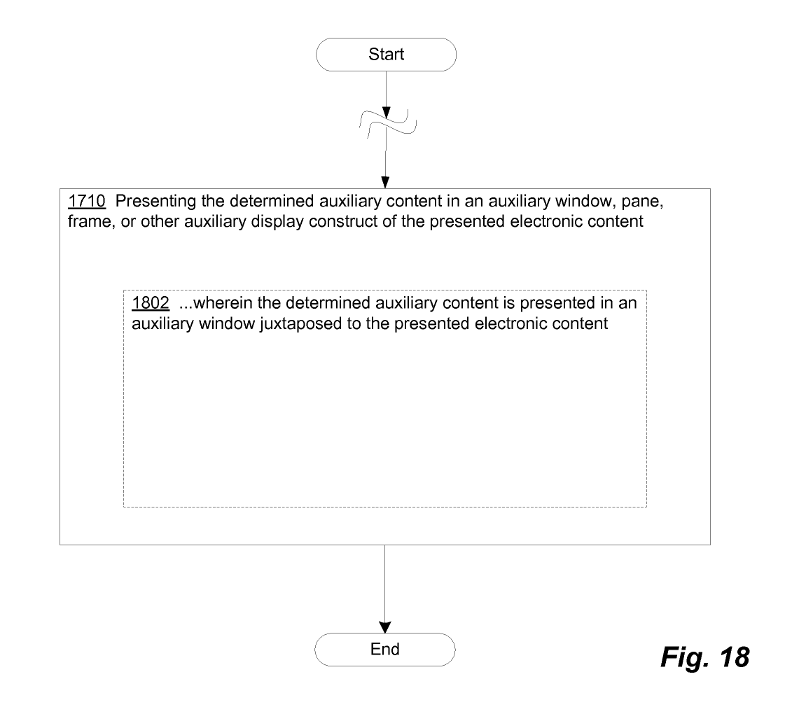

FIG. 18 is an example flow diagram of example logic illustrating an example embodiment of block 1710 of FIG. 17. The logic of operation 1710 for presenting the determined auxiliary content in an auxiliary window, pane, frame, or other auxiliary display construct of the presented electronic content may include an operation 1802 whose logic specifies that determined auxiliary content is presented in an auxiliary window juxtaposed to the presented electronic content. The logic of operation 1802 may be performed, for example, by auxiliary display generation module 256 provided by the presentation module 118 of the GBCMS 110 as described in FIGS. 2A and 2H. The auxiliary content may be presented in a juxtaposition (e.g., next to, connected, nearby, proximate to, coincident with) to allow the user (user 10*) to continue to view and/or operate on the contents of the presented electronic content.

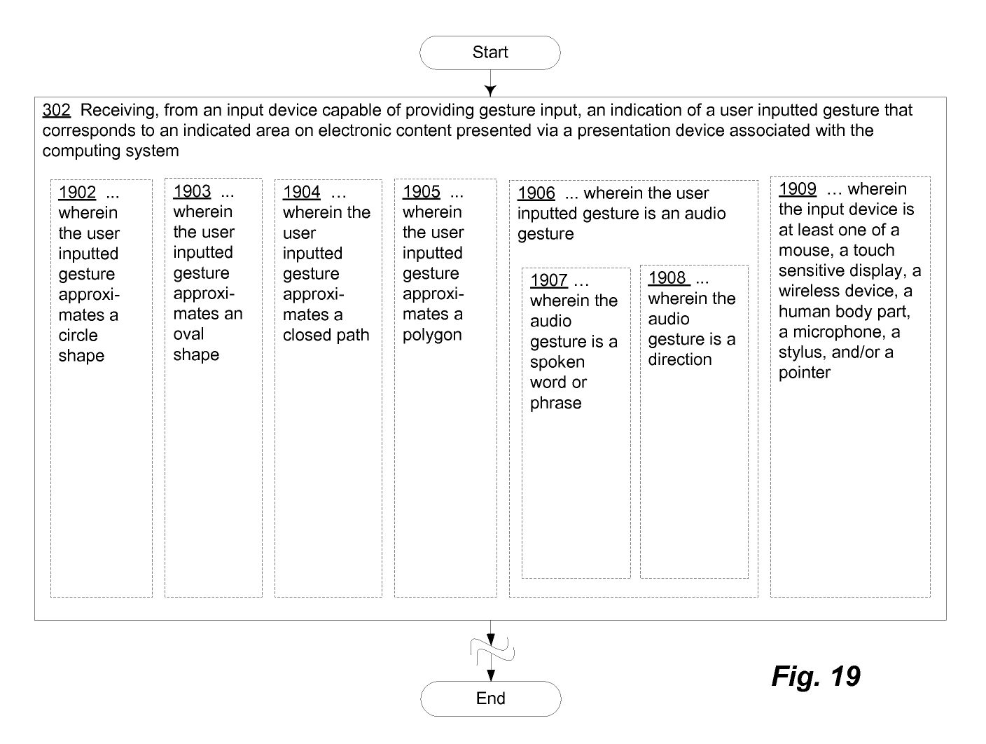

FIG. 19 is an example flow diagram of example logic illustrating various example embodiments of block 302 of FIG. 3. The logic of operation 302 for receiving, from an input device capable of providing gesture input, an indication of a user inputted gesture that corresponds to an indicated area of electronic content presented via a presentation device associated with the computing system may include an operation 1902 whose logic specifies that the user inputted gesture approximates a circle shape. The logic of operation 1902 may be performed, for example, by the graphics handling module 224 provided by the gesture input detection and resolution module 121 provided by the input module 111 of the GBCMS 110 described with reference to FIGS. 2A and 2B to detect whether a received gesture is in a form that approximates a circle shape.

In the same or different embodiments, operation 302 may include an operation 1903 whose logic specifies the user inputted gesture approximates an oval shape. The logic of operation 1903 may be performed, for example, by the graphics handling module 224 provided by the gesture input detection and resolution module 121 provided by the input module 111 of the GBCMS 110 described with reference to FIGS. 2A and 2B to detect whether a received gesture is in a form that approximates an oval shape.

In the same or different embodiments, operation 302 may include operation 1904 whose logic specifies that the user inputted gesture approximates a closed path. The logic of operation 1904 may be performed, for example, by the graphics handling module 224 provided by the gesture input detection and resolution module 121 provided by the input module 111 of the GBCMS 110 described with reference to FIGS. 2A and 2B to detect whether a received gesture is in a form that approximates an closed path.

In the same or different embodiments, operation 302 may include operation 1905 whose logic specifies that the user inputted gesture approximates a polygon. The logic of operation 1905 may be performed, for example, by the graphics handling module 224 provided by the gesture input detection and resolution module 121 provided by the input module 111 of the GBCMS 110 described with reference to FIGS. 2A and 2B to detect whether a received gesture is in a form that approximates a polygon.

In the same or different embodiments, operation 302 may include operation 1906 whose logic specifies that the user inputted gesture is an audio gesture. The logic of operation 1906 may be performed, for example, by the audio handling module 222 provided by the gesture input detection and resolution module 121 provided by the input module 111 of the GBCMS 110 described with reference to FIGS. 2A and 2B to detect whether a received gesture is an audio gesture, such as received via audio device, microphone 20b.

In some embodiments, operation 1906 may further include operation 1907 whose logic specifies that the audio gesture is a spoken word or phrase. The logic of operation 1907 may be performed, for example, by the audio handling module 222 provided by the gesture input detection and resolution module 121 provided by the input module 111 of the GBCMS 110 described with reference to FIGS. 2A and 2B to detect whether a received gesture is an audio gesture, such as received via audio device, microphone 20b, indicates (e.g., designates or otherwise selects) a word or phrase indicating some portion of the presented content.

In the same or different embodiments, operation 1906 may include operation 1908 whose logic specifies that the audio gesture is a direction. The logic of operation 1908 may be performed, for example, by the audio handling module 222 provided by the gesture input detection and resolution module 121 provided by the input module 111 of the GBCMS 110 described with reference to FIGS. 2A and 2B to detect a direction received from an audio input device, such as audio input device 20b. The direction may be, for example, a single letter, number, word, phrase, or any type of instruction or indication of where to move a cursor or locator device.

In the same or different embodiments, operation 302 may include operation 1909 whose logic specifies that the audio gesture is at least one of a mouse, a touch sensitive display, a wireless device, a human body part, a microphone, a stylus, and/or a pointer. The logic of operation 1909 may be performed, for example, by the specific device handlers 125 in conjunction with the gesture input detection and resolution module 121 provided by the input module 111 of the GBCMS 110 described with reference to FIGS. 2A and 2B to detect to detect and resolve (e.g., determine, figure out, or the like) input from an input device 20*.

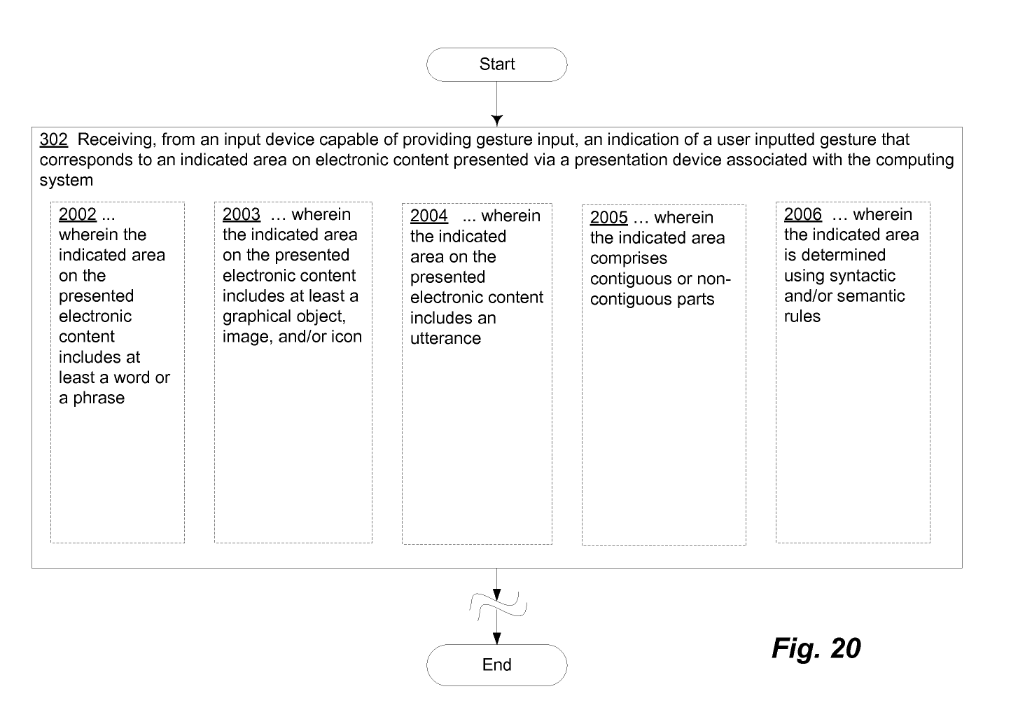

FIG. 20 is an example flow diagram of example logic illustrating various example embodiments of block 302 of FIG. 3. The logic of operation 302 for receiving, from an input device capable of providing gesture input, an indication of a user inputted gesture that corresponds to an indicated area of electronic content presented via a presentation device associated with the computing system may include an operation 2002 whose logic specifies that the indicated area on the presented electronic content includes at least a word or a phrase. The logic of operation 2002 may be performed, for example, by the natural language processing module 226 provided by the gesture input detection and resolution module 121 of the input module 111 of the GBCMS 110 described with reference to FIGS. 2A and 2B to detect and resolve gesture input from, for example, devices 20*. In this case the natural language processing module 226 may be used to decipher word or phrase boundaries when, for example, the user 10* designates a circle, oval, polygon, closed path, etc. gesture that does not really map one to one with one or more words. Other attributes of the document and the user's prior navigation history may influence the ultimate word or phrase detected by the gesture input and resolution module 121.

In the same or different embodiments, operation 302 may include an operation 2003 whose logic specifies the indicated area on the presented electronic content includes at least a graphical object, image, and/or icon. The logic of operation 2003 may be performed, for example, by the graphics handling module 224 of the gesture input detection and resolution module 121 of the input module 111 of the GBCMS 110 described with reference to FIGS. 2A and 2B to detect and resolve gesture input from, for example, devices 20*.

In the same or different embodiments, operation 302 may include an operation 2004 whose logic specifies the indicated area on the presented electronic content includes an utterance. The logic of operation 2004 may be performed, for example, by the audio handling module 222 provided by the gesture input detection and resolution module 121 provided by the input module 111 of the GBCMS 110 described with reference to FIGS. 2A and 2B to detect whether a received gesture is an audio gesture such as an utterance (e.g., sound, word, phrase, or the like) received from audio device microphone 20b.

In the same or different embodiments, operation 302 may include an operation 2005 whose logic specifies the indicated area comprises either non-contiguous parts or contiguous parts. The logic of operation 2005 may be performed, for example, by the gesture input detection and resolution module 121 provided by the input module 111 of the GBCMS 110 described with reference to FIGS. 2A and 2B to detect whether multiple portions of the presented content are indicated by the user as gestured-input. This may occur, for example, if the gesture is initiated using an audio device or using a pointing device capable of cumulating discrete gestures.

In the same or different embodiments, operation 302 may include an operation 2006 whose logic specifies the indicated area is determined using syntactic and/or semantic rules. The logic of operation 2006 may be performed, for example, by natural language processing module 226 provided by the gesture input detection and resolution module 121 of the input module 111 of the GBCMS 110 described with reference to FIGS. 2A and 2B to detect and resolve gesture input from, for example, devices 20*. In this case the natural language processing module 226 may be used to apply syntactic and/or semantic rules to decipher word, phrase, sentence, and the like boundaries. As described elsewhere, NLP-based mechanisms may be employed to determine what is meant by a gesture and hence what auxiliary content may be meaningful.

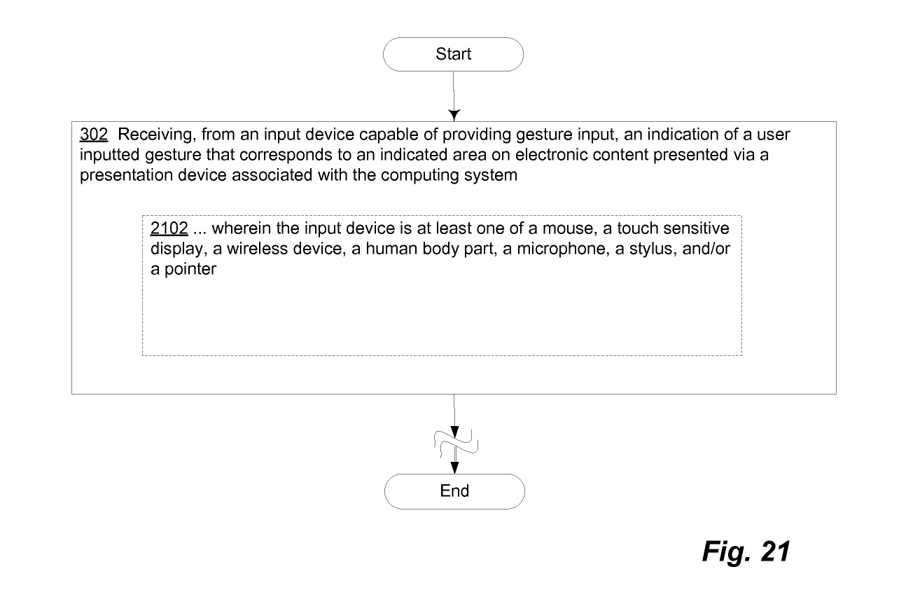

FIG. 21 is an example flow diagram of example logic illustrating an example embodiment of block 302 of FIG. 3. The logic of operation 302 for receiving, from an input device capable of providing gesture input, an indication of a user inputted gesture that corresponds to an indicated area of electronic content presented via a presentation device associated with the computing system may include an operation 2102 whose logic specifies that the input device is at least one of a mouse, a touch sensitive display, a wireless device, a human body part, a microphone, a stylus, and/or a pointer. The logic of operation 2102 may be performed, for example, by the specific device handlers 125 in conjunction with the gesture input detection and resolution module 121 provided by the input module 111 of the GBCMS 110 described with reference to FIGS. 2A and 2B to detect to detect and resolve input from an input device 20*.

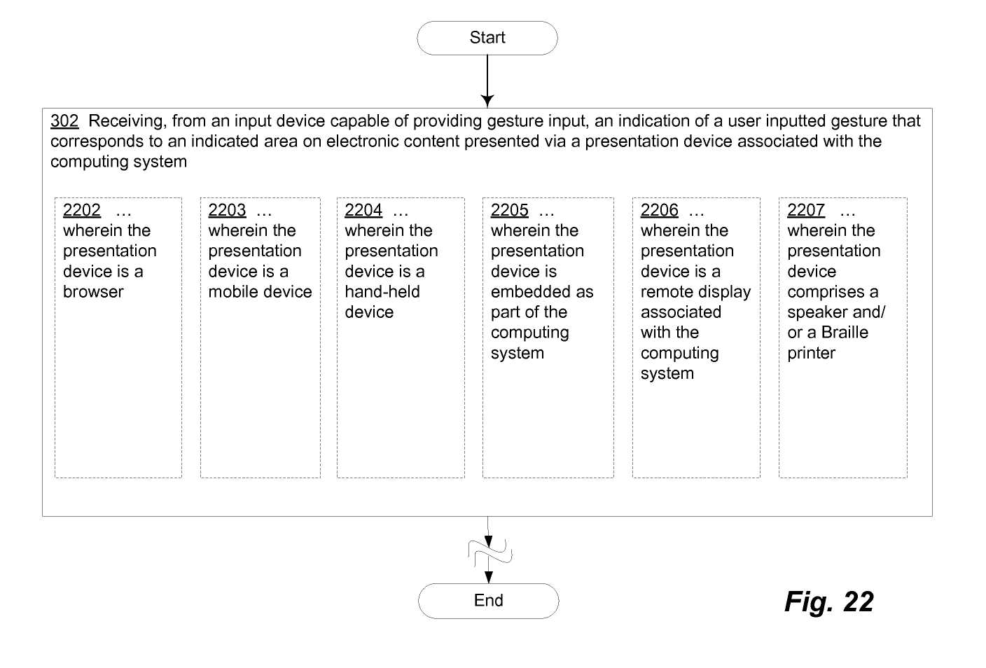

FIG. 22 is an example flow diagram of example logic illustrating various example embodiments of block 302 of FIG. 3. The logic of operation 302 for receiving, from an input device capable of providing gesture input, an indication of a user inputted gesture that corresponds to an indicated area of electronic content presented via a presentation device associated with the computing system may include an operation 2202 whose logic specifies that the presentation device is a browser. The logic of operation 2202 may be performed, for example, by specific device handlers 258 provided by the presentation module 118 of the GBCMS 110 as described with reference to FIGS. 2A and 2H.

In the same or different embodiments, operation 302 may include an operation 2203 whose logic specifies that the presentation device is a mobile device. The logic of operation 2203 may be performed, for example, by specific device handlers 258 provided by the presentation module 118 of the GBCMS 110 as described with reference to FIGS. 2A and 2H. Mobile devices may include any type of device, digital or analog, that can be made mobile, including, for example, a cellular phone, table, personal digital assistant, computer, laptop, radio, and the like.

In the same or different embodiments, operation 302 may include an operation 2204 whose logic specifies that the presentation device is a hand-held device. The logic of operation 2204 may be performed, for example, by specific device handlers 258 provided by the presentation module 118 of the GBCMS 110 as described with reference to FIGS. 2A and 2H. Hand-held devices may include any type of device, digital or analog, that can be held, for example, a cellular phone, table, personal digital assistant, computer, laptop, radio, and the like.

In the same or different embodiments, operation 302 may include an operation 2205 whose logic specifies that the presentation device is embedded as part of the computing system. The logic of operation 2205 may be performed, for example, by specific device handlers 258 provided by the presentation module 118 of the GBCMS 110 as described with reference to FIGS. 2A and 2H. Embedded devices include, for example, devices that have smart displays built into them, display screens specially constructed for the computing system, etc.

In the same or different embodiments, operation 302 may include an operation 2206 whose logic specifies that the presentation device is a remote display associated with the computing system. The logic of operation 2206 may be performed, for example, by specific device handlers 258 provided by the presentation module 118 of the GBCMS 110 as described with reference to FIGS. 2A and 2H. The remote display may be accessible, for example, over the networks 30, which are communicatively coupled to the GBCMS 110.

In the same or different embodiments, operation 302 may include an operation 2207 whose logic specifies that the presentation device comprises a speaker or a Braille printer. The logic of operation 2207 may be performed, for example, by specific device handlers 258 provided by the presentation module 118 of the GBCMS 110 as described with reference to FIGS. 2A and 2H, including the speaker device handler.

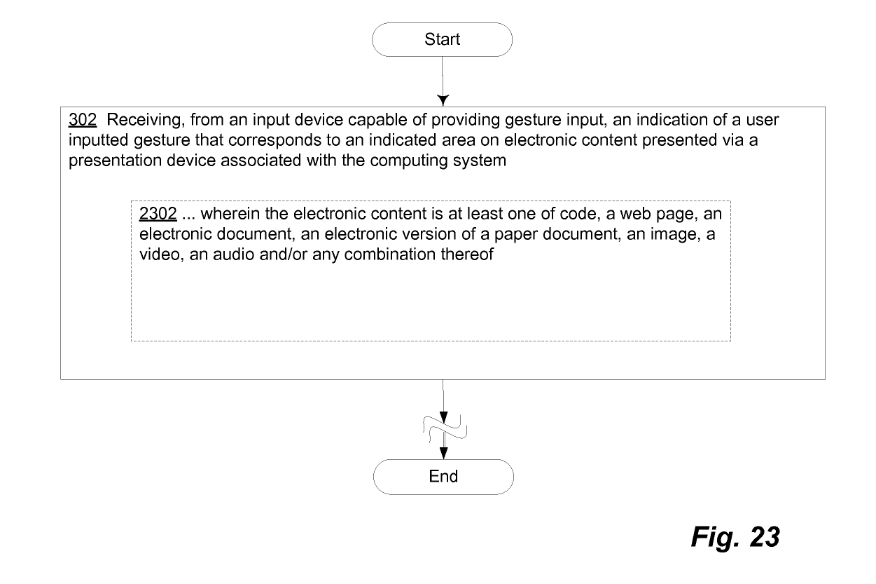

FIG. 23 is an example flow diagram of example logic illustrating an example embodiment of block 302 of FIG. 3. The logic of operation 302 for receiving, from an input device capable of providing gesture input, an indication of a user inputted gesture that corresponds to an indicated area of electronic content presented via a presentation device associated with the computing system may include an operation 2302 whose logic specifies that the electronic content is at least one of code, a web page, an electronic document, an electronic version of a paper document, an image, a video, an audio and/or any combination thereof. The logic of operation 2302 may be performed, for example, by the input module 111 of the GBCMS 110 as described with reference to FIGS. 2A and 2B. The electronic content can be any content capable of being rendered electronically.

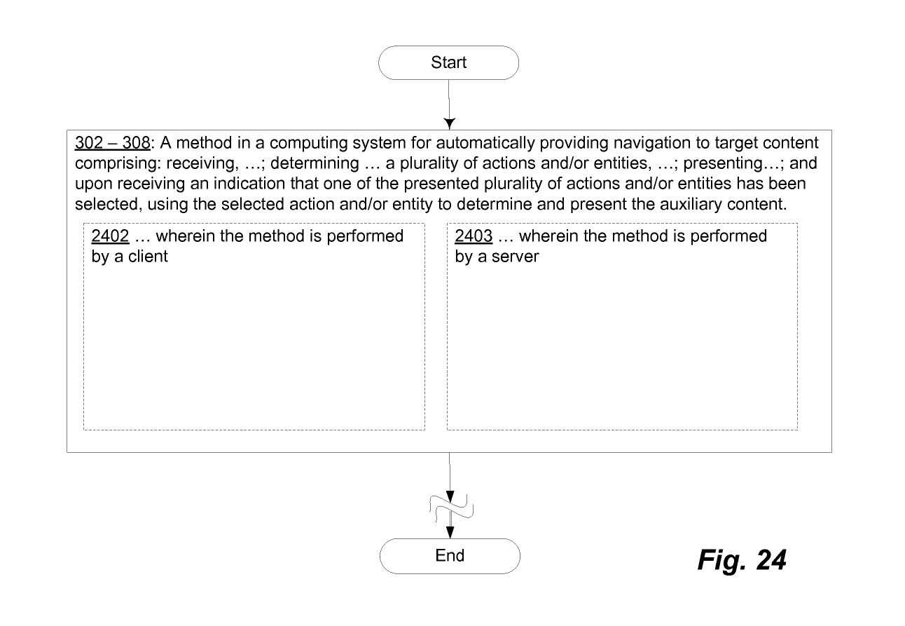

FIG. 24 is an example flow diagram of example logic illustrating various example embodiments of blocks 302 to 310 of FIG. 3. In particular, the logic of the operations 302 to 310 may further include logic 2402 that specifies that the entire method is performed by a client. As described earlier, a client may be hardware, software, or firmware, physical or virtual, and may be part or the whole of a computing system. A client may be an application or a device.

In the same or different embodiments, the logic of the operations 302 to 310 may further include logic 2403 that specifics that the entire method is performed by a server. As described earlier, a server may be hardware, software, or firmware, physical or virtual, and may be part or the whole of a computing system. A server may be service as well as a system.

FIG. 25 is an example block diagram of a computing system for practicing embodiments of a Gesture Based Context Menu System as described herein. Note that a general purpose or a special purpose computing system suitably instructed may be used to implement an GBCMS, such as GBCMS 110 of FIG. 1E.

Further, the GBCMS may be implemented in software, hardware, firmware, or in some combination to achieve the capabilities described herein.

The computing system 100 may comprise one or more server and/or client computing systems and may span distributed locations. In addition, each block shown may represent one or more such blocks as appropriate to a specific embodiment or may be combined with other blocks. Moreover, the various blocks of the GBCMS 110 may physically reside on one or more machines, which use standard (e.g., TCP/IP) or proprietary interprocess communication mechanisms to communicate with each other.

In the embodiment shown, computer system 100 comprises a computer memory (“memory”) 101, a display 2502, one or more Central Processing Units (“CPU”) 2503, Input/Output devices 2504 (e.g., keyboard, mouse, CRT or LCD display, etc.), other computer-readable media 2505, and one or more network connections 2506. The GBCMS 110 is shown residing in memory 101. In other embodiments, some portion of the contents, some of, or all of the components of the GBCMS 110 may be stored on and/or transmitted over the other computer-readable media 2505. The components of the GBCMS 110 preferably execute on one or more CPUs 2503 and manage providing automatic navigation to auxiliary content, as described herein. Other code or programs 2530 and potentially other data stores, such as data repository 2520, also reside in the memory 101, and preferably execute on one or more CPUs 2503. Of note, one or more of the components in FIG. 25 may not be present in any specific implementation. For example, some embodiments embedded in other software may not provide means for user input or display.

In a typical embodiment, the GBCMS 110 includes one or more input modules 111, one or more context menu handling modules 112, one or more context menu view modules 113, one or more action and/or entity determination modules 114, one or more rules for deriving actions and/or entities 115, one or more auxiliary content determination modules 117, and one or more presentation modules 118. In at least some embodiments, some data is provided external to the GBCMS 110 and is available, potentially, over one or more networks 30. Other and/or different modules may be implemented. In addition, the GBCMS 110 may interact via a network 30 with application or client code 2555 that can absorb context menus, for example, for other purposes, one or more client computing systems or client devices 20*, and/or one or more third-party content provider systems 2565, such as third party advertising systems or other purveyors of auxiliary content. Also, of note, the history data repository 2515 may be provided external to the GBCMS 110 as well, for example in a knowledge base accessible over one or more networks 30.

In an example embodiment, components/modules of the GBCMS 110 are implemented using standard programming techniques. However, a range of programming languages known in the art may be employed for implementing such example embodiments, including representative implementations of various programming language paradigms, including but not limited to, object-oriented (e.g., Java, C++, C#, Smalltalk, etc.), functional (e.g., ML, Lisp, Scheme, etc.), procedural (e.g., C, Pascal, Ada, Modula, etc.), scripting (e.g., Perl, Ruby, Python, JavaScript, VBScript, etc.), declarative (e.g., SQL, Prolog, etc.), etc.

The embodiments described above may also use well-known or proprietary synchronous or asynchronous client-server computing techniques. However, the various components may be implemented using more monolithic programming techniques as well, for example, as an executable running on a single CPU computer system, or alternately decomposed using a variety of structuring techniques known in the art, including but not limited to, multiprogramming, multithreading, client-server, or peer-to-peer, running on one or more computer systems each having one or more CPUs. Some embodiments are illustrated as executing concurrently and asynchronously and communicating using message passing techniques. Equivalent synchronous embodiments are also supported by an GBCMS implementation.

In addition, programming interfaces to the data stored as part of the GBCMS 110 (e.g., in the data repositories 2515 and 2516) can be available by standard means such as through C, C++, C#, Visual Basic.NET and Java APIs; libraries for accessing files, databases, or other data repositories; through scripting languages such as XML; or through Web servers, FTP servers, or other types of servers providing access to stored data. The repositories 2515 and 2516 may be implemented as one or more database systems, file systems, or any other method known in the art for storing such information, or any combination of the above, including implementation using distributed computing techniques.

Also the example GBCMS 110 may be implemented in a distributed environment comprising multiple, even heterogeneous, computer systems and networks. Different configurations and locations of programs and data are contemplated for use with techniques of described herein. In addition, the server and/or client components may be physical or virtual computing systems and may reside on the same physical system. Also, one or more of the modules may themselves be distributed, pooled or otherwise grouped, such as for load balancing, reliability or security reasons. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, etc.) etc. Other variations are possible. Also, other functionality could be provided by each component/module, or existing functionality could be distributed amongst the components/modules in different ways, yet still achieve the functions of an GBCMS.

Furthermore, in some embodiments, some or all of the components of the GBCMS 110 may be implemented or provided in other manners, such as at least partially in firmware and/or hardware, including, but not limited to one or more application-specific integrated circuits (ASICs), standard integrated circuits, controllers executing appropriate instructions, and including microcontrollers and/or embedded controllers, field-programmable gate arrays (FPGAs), complex programmable logic devices (CPLDs), and the like. Some or all of the system components and/or data structures may also be stored as contents (e.g., as executable or other machine-readable software instructions or structured data) on a computer-readable medium (e.g., a hard disk; memory; network; other computer-readable medium; or other portable media article to be read by an appropriate drive or via an appropriate connection, such as a DVD or flash memory device) to enable the computer-readable medium to execute or otherwise use or provide the contents to perform at least some of the described techniques. Some or all of the components and/or data structures may be stored on tangible, non-transitory storage mediums. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

All of the above U.S. patents, U.S. patent application publications, U.S. Patent applications, foreign patents, foreign patent applications and non-patent publications referred to in this specification and/or listed in the Application Data Sheet, are incorporated herein by reference, in their entireties.

From the foregoing it will be appreciated that, although specific embodiments have been described herein for purposes of illustration, various modifications may be made without deviating from the spirit and scope of the claims. For example, the methods and systems for performing automatic navigation to auxiliary content discussed herein are applicable to other architectures other than a windowed or client-server architecture. Also, the methods and systems discussed herein are applicable to differing protocols, communication media (optical, wireless, cable, etc.) and devices (such as wireless handsets, electronic organizers, personal digital assistants, tablets, portable email machines, game machines, pagers, navigation devices such as GPS receivers, etc.).

1. A method in a computing system for providing a gesture based context based for presenting content, comprising:
receiving, from an input device capable of providing gesture input, an indication of a user inputted gesture that corresponds to an indicated area of electronic content presented via a presentation device associated with the computing system;
determining, based upon the indicated area and a set of criteria, a plurality of actions and/or entities that may be used with the indicated area to provide auxiliary content;
presenting the determined plurality of actions and/or entities in a context menu; and
upon receiving an indication that one of the presented plurality of actions and/or entities has been selected, using the selected action and/or entity to determine and present the auxiliary content.

2. The method of claim 1 wherein the determining, based upon the indicated area and a set of criteria, a plurality of actions and/or entities that may be used with the indicated area to provide auxiliary content further comprises:
determining a plurality of actions and/or entities based upon a set of rules used to convert one or more nouns that relate to the indicated area into corresponding verbs.

3. The method of claim 2, the determining a plurality of actions and/or entities based upon a set of rules used to convert one or more nouns that relate to the indicated area into corresponding verbs further comprising:
deriving the plurality of actions and/or entities by determining a set of most frequently occurring words in the electronic content and converting the set into corresponding verbs.

4. The method of claim 2, the determining a plurality of actions and/or entities based upon a set of rules used to convert one or more nouns that relate to the indicated area into corresponding verbs further comprising:
deriving the plurality of actions and/or entities by determining a set of most frequently occurring words in proximity to the indicated area and converting the set into corresponding verbs.

5. The method of claim 2, the determining a plurality of actions and/or entities based upon a set of rules used to convert one or more nouns that relate to the indicated area into corresponding verbs further comprising:
deriving the plurality of actions and/or entities by determining a set of common verbs used with one or more entities encompassed by the indicated area.

6. The method of claim 5, the deriving the plurality of actions and/or entities by determining a set of common verbs used with one or more entities encompassed by the indicated area, further comprising:
determining one or more entities located with the indicated area;
searching the electronic content to determine all uses of the one or more entities and for each such entity, a corresponding verb;
determining from the corresponding verbs a set of most frequently occurring verbs; and
using the determined set of most frequently occurring verbs as the set of common verbs.

7. The method of claim 2, the determining a plurality of actions and/or entities based upon a set of rules used to convert one or more nouns that relate to the indicated area into corresponding verbs further comprising:
generating the plurality of actions and/or entities by determining a set of default actions.

8. The method of claim 7 wherein the default actions include actions that specify some form of buying or shopping, sharing, exploring and/or obtaining information.

9. The method of claim 7 wherein the default actions include an action to find a better <entity>, where <entity> is an entity encompassed by the indicated area.

10. The method of claim 7 wherein the default actions include an action to share a <entity>, where <entity> is an entity encompassed by or related to the indicated area.

11. The method of claim 7 wherein the default actions include an action to obtain information about a <entity>, where <entity> is an entity encompassed by or related to the indicated area.

12. The method of claim 7 wherein the default actions include one or more actions that specify comparative actions.

13. The method of claim 12 wherein the comparative actions include an action to obtain an entity sooner.

14. The method of claim 12 wherein the comparative actions include an action to purchase an entity cheaper.

15. The method of claim 12 wherein the comparative actions include an action to find a better deal.

16. The method of claim 1 wherein the determining, based upon the indicated area and a set of criteria, a plurality of actions and/or entities that may be used with the indicated area to provide auxiliary content further comprises:
determining a plurality of actions and/or entities based upon a social network associated with the user.

17. The method of claim 16 wherein determining a plurality of actions and/or entities based upon a social network associated with the user comprises:
predicting a set of actions based upon similar actions taken by other users in the social network associated with the user.

18. The method of claim 1 wherein the set of criteria includes prior history associated with the user and the determining, based upon the indicated area and a set of criteria, a plurality of actions and/or entities that may be used with the indicated area to provide auxiliary content further comprises:
selecting a plurality of actions and/or entities based upon prior history associated with the user.

19. The method of claim 18 wherein the prior history associated with the user includes at least one of prior search history, prior navigation history, prior purchase history, and/or demographic information.

20.-22. (canceled)

23. The method of claim 22 wherein the prior history associated with the user includes demographic information and the demographic information including at least one of age, gender, and/or a location associated with the user.

24. The method of claim 1 wherein the set of criteria includes an attribute of the gesture and the determining, based upon the indicated area and a set of criteria, a plurality of actions and/or entities that may be used with the indicated area to provide auxiliary content further comprises:
determining a plurality of actions and/or entities based upon an attribute of the gesture.

25. The method of claim 24 wherein the attribute of the gesture is at least one of a size, a direction, a color of the gesture, and/or a measure of steering of the gesture.

26.-28. (canceled)

29. The method of claim 1 wherein the set of criteria includes a context of other text, audio, graphics, and/or objects within the presented electronic content and the determining, based upon the indicated area and a set of criteria, a plurality of actions and/or entities that may be used with the indicated area to provide auxiliary content further comprises:
determining a plurality of actions and/or entities based upon the context of other text, audio, graphics, and/or objects within the presented electronic content.

30. The method of claim 1, further comprising:
receiving an indication that the user inputted gesture has been adjusted; and
dynamically modifying the presented plurality of actions and/or entities in the context menu.

31. The method of claim 30, further comprising:
determining and presenting a second auxiliary content based upon the adjusted user inputted gesture.

32. The method of claim 30 wherein the receiving an indication that the user inputted gesture has been adjusted and the dynamically modifying the presented plurality of actions and/or entities in the context menu further comprises:
receiving an indication that the gesture has at least changed in size, changed in direction, changed in emphasis, and/or changed in type of gesture; and
dynamically modifying the presented plurality of actions and/or entities in the context menu based upon the gesture change.

33. The method of claim 30 wherein the modified presented plurality of actions and/or entities are used to determine and present the auxiliary content.

34. The method of claim 1 wherein the context menu is presented as at least one of a drop down menu, a pop-up menu, or an interest wheel.

35.-36. (canceled)

37. The method of claim 1 wherein the context menu is rectangular shaped.

38. The method of claim 1 wherein the context menu is non-rectangular shaped.

39. The method of claim 1 wherein the auxiliary content is at least one of an advertisement, an opportunity for commercialization, and/or supplemental content.

40. The method of claim 39 wherein the auxiliary content is at least one of a computer-assisted competition, a bidding opportunity, a sale or an offer for sale of a product and/or a service, and/or interactive entertainment.

41. The method of claim 1 wherein the auxiliary content is at least one of a web page, an electronic document, and/or an electronic version of a paper document.

42. The method of claim 1, the using the selected action to determine and present the auxiliary content, further comprising:
determining an auxiliary content based upon the selected action and at least one of the indicated area and/or the set of criteria; and
presenting the determined auxiliary content.

43. The method of claim 1, further comprising:
presenting the determined auxiliary content as an overlay on top of the presented electronic content.

44. The method of claim 43 wherein the determining an auxiliary content based upon the selected action and at least one of the indicated area and/or the set of criteria is made visible using animation techniques and/or by causing a pane to appear as though the pane is caused to slide from one side of the presentation device onto the presented electronic content.

45. The method of claim 1, further comprising:
presenting the determined auxiliary content in an auxiliary window, pane, frame, or other auxiliary display construct of the presented electronic content.

46. (canceled)

47. The method of claim 1 wherein the user inputted gesture approximates at least one of a circle shape, an oval shape, a closed path, and/or a polygon.

48.-50. (canceled)

51. The method of claim 1 wherein the user inputted gesture is an audio gesture.

52.-54. (canceled)

55. The method of claim 1 wherein the indicated area on the presented electronic content includes at least a word or a phrase, a graphical object, an image, and/or an icon.

56. (canceled)

57. The method of claim 1 wherein the indicated area on the presented electronic content includes an utterance.

58. The method of claim 1 wherein the indicated area comprises either non-contiguous parts or contiguous parts.

59. The method of claim 1 wherein the indicated area is determined using syntactic and/or semantic rules.

60. The method of claim 1 wherein the input device is at least one of a mouse, a touch sensitive display, a wireless device, a human body part, a microphone, a stylus, and/or a pointer.

61. The method of claim 1 wherein the presentation device is at least one of a browser, a mobile device, a hand-held device, embedded as part of the computing system, a remote display associated with the computing system, a speaker, or a Braille printer.

62.-66. (canceled)

67. The method of claim 1 wherein the electronic content is at least one of code, a web page, an electronic document, an electronic version of a paper document, an image, a video, an audio and/or any combination thereof.

68. The method of claim 1 performed by a client or a server.

69.-210. (canceled)
